(19) United States
(12) Patent Application Publication
(10) Pub. No.: US 2013/0325541 A1
(43) Pub. Date: Dec. 5, 2013

(54) SYSTEM AND METHOD FOR MANAGING AND PROVIDING VEHICLE MAINTENANCE

(71) Applicants: John A. Capriotti, Jupiter, FL (US); Stephen Smith, Palm Beach Gardens, FL (US)

(72) Inventors: John A. Capriotti, Jupiter, FL (US); Stephen Smith, Palm Beach Gardens, FL (US)

(21) Appl. No.: 13/889,933

(22) Filed: May 8, 2013

Related U.S. Application Data
(60) Provisional application No. 61/644,286, filed on May 8, 2012.

(51) Int. Cl. G06Q 10/00; G06Q 10/10

(52) U.S. Cl. CPC G06Q 10/20; G06Q 10/1097
USPC 705/7.21

(57) ABSTRACT

A method for managing vehicle maintenance information set to utilize information obtained from a vehicle owner and a vehicle service provider to alert and educate the vehicle owner and the vehicle service provider about recommended maintenance scheduling, specific vehicle parts and repair requirements, vehicle diagnosis information, vehicle service history, real-time inventory management, vehicle maintenance costs, and scheduling of vehicle owners for vehicle maintenance at the maintenance facility. The system may coordinate the vehicle's maintenance information with the vehicle service provider and the vehicle owner through the use of various communication technologies and novel methods.

### CROSS-REFERENCE TO RELATED APPLICATION

This application claims priority to U.S. Provisional Patent Application No. 61/644,286 filed May 8, 2012, the entirety of which is incorporated by reference.

### FIELD OF THE INVENTION

The present invention relates generally to a system and method for managing and providing motor vehicle maintenance, and, more particularly, relates to a method and system for obtaining motor vehicle, customer, and maintenance information and storing, monitoring, editing, and associating that information to alert and educate a motor vehicle owner and the vehicle service provider about recommended maintenance scheduling, alert the user of repair requirements, vehicle diagnosis information, vehicle service history, real-time inventory management, vehicle maintenance costs, facilitate directed advertising, and schedule vehicle owners for vehicle maintenance at the vehicle service provider's facility.

### BACKGROUND OF THE INVENTION

It is well known that motor vehicles require periodic maintenance in order to maintain their efficiency, safety, comfort, longevity, and in some cases, their functionality. Generally, designers, manufacturers, or distributors of these motor vehicles estimate intervals of time or miles when maintenance is required or recommended to retain the vehicle's efficiency. This information is generally contained in a vehicle's owner's manual. These maintenance intervals vary depending on parameters such as the year, make, and model of the vehicle, the driving conditions, driver behavior, present and expected mileage on the vehicle, the number of trips and distance traveled per trip per day, extreme hot or cold climate conditions, mountainous, dusty or de-iced roads, city vs. highway traveling, or towing a trailer or other heavy load. Although the driver's manual remains generally accurate in terms of miles and elapsed time between services, it cannot take many of the other conditions, e.g., climate conditions, driver's habits, etc., into account and must, instead, rely on the recommended intervals based on averages that apply to all automobiles/drivers.

It is also known that those parts and accessories associated with a motor vehicle also have projected life spans. It is further known that, even with a user's attention to those maintenance or repair schedules, a motor vehicle may still malfunction. Whether it is regular scheduled maintenance or an unanticipated repair, most persons consult the help of a vehicle service provider. The vehicle service provider generally consists of a sales/parts associate and the technicians performing the actual maintenance. Generally, bringing in a vehicle for maintenance involves the monotonous tasks of giving all of the customer's information, explaining the problems, having the vehicle inspected by the sales associate, the service provider inspecting or testing the condition of vehicle subsystems, such as the engine or transmission, and servicing the problems at issue. As such, the customer-to-associate-to-technician communication is important for accurate, efficient, and timely service.

Common vehicle maintenance tasks may also include the following: car wash; check/replace the engine oil and replace oil filters; check/replace fuel filters; inspect or replace windshield wipers; check or refill windshield washer fluid; inspect tires for pressure and wear; tire balancing; tire rotation; wheel alignment; check, clean, or replace battery terminals and top up battery fluid; inspect or replace brake pads; check or flush brake fluid; check or flush transmission fluid; check or flush power steering fluid; check and flush engine coolant; inspect or replace spark plugs; inspect or replace air filter; inspect or replace timing belt and other belts; lubricate locks, latches, hinges; check all lights; test electronics, e.g., anti-lock braking system or ABS; and read fault codes from the engine control unit (ECU).

In order to maintain resale or trade-in values for certain leased or owned motor vehicles or to obtain incentives when the vehicle is traded in, many vehicle dealers require the vehicle to conform to the manufacturer's maintenance schedule. For many vehicle owners, remembering even basic maintenance, such as the changing of oil in the vehicle is problematic. Furthermore, the vast majority of individuals who or entities which own, operate, and/or use, vehicles, are usually unable to, and/or are usually not equipped to, perform repairs, maintenance procedures, or servicing procedures, on their vehicles. As a result, regular vehicle maintenance is less frequently attempted by the vehicle owner, and is more and more frequently relegated to car dealers, service stations, and other specialized service facilities. This is in part because the vehicle owner lacks the know-how to repair, maintain, and/or service the vehicle or because, like many owners, has difficulty finding time to do the maintenance themselves. Consequently, owners may often wait until it is too late to service their vehicles. At that point, costly repairs or servicing may be required, which can also include costs and expenses, which may be incurred relating to a need to replace expensive parts, components, and/or equipment.

To solve the above issues, some known systems have been created to integrate communication-based technology with vehicle maintenance. These systems store digital records online for the user to view and possibly be notified of general vehicle maintenance schedules, associate mechanical parts with the vehicle, store vehicle owner information, and previous maintenance information associated with an owner's vehicle. These systems, however, are not linked or connected directly to a vehicle service provider. For example, there is no communication between a vehicle owner and a vehicle service provider during or before recommended maintenance times.

Furthermore, these systems do not incorporate information, specifically maintenance intervals, from all of the owner's manuals for every car manufacture in order for it to be accessible to the users. Additionally, those systems do not communicate, or track, that information to the owner based on an updated basis, depending on the vehicle's miles or time interval from the owner's last maintenance service. Furthermore, those systems do not allow the owner to monitor or be updated of other vehicles owned, e.g., a daughter's car, without the owner manually obtaining and entering that information him or herself. Because of the wide variety of makes, models, engine sizes, and other vehicle options available, a vehicle service provider must have access to each vehicle's particular maintenance schedules in order to make appropriate recommendations and schedule maintenance service for each vehicle. Vehicle owners themselves often fail to have this information, and often cannot remember, or do not fully comprehend the type or parts that the last maintenance entailed.

Moreover, these attempts at managing vehicle maintenance with technology were deficient, as they do not involve integrating the actual maintenance and repairs with the maintenance information provided without the owner's actual input. Many of these known systems do not provide a comprehensive maintenance solution. Rather, they are efforts designed to facilitate a segment of the vehicle maintenance and information dilemma. And while vehicle technology has continued to develop and advance, the development of technology for receiving, providing, coordinating, and managing information regarding vehicle maintenance, and coordinating this with the actual physical maintenance is not sufficient to provide busy and uninitiated vehicle owners with the proper vehicle maintenance they deserve or that is required.

Traditionally, when a customer brings in a vehicle for repair or maintenance, many known service providers diagnose the issues of the vehicle without knowing and, most importantly, factoring in, any of customer's prior or current maintenance information. This may hinder the service associate or technician in diagnosing the vehicle's problem. Some systems provide a customer with the ability to provide certain information associated with the vehicle, but those systems do not provide an effective and efficient method of storing or transferring that information to the service provider. For example, most systems are not in communication with a data storage site that stores this information and allows the customer to create or update this information themself. Further, these systems do not allow a vehicle's current information, such as miles traveled or average speed, to be automatically transferred to the service provider where it can be used to recommend parts and/or maintenance services.

In addition to not knowing the owner's prior maintenance information, those known systems do not allow a vehicle owner to schedule future maintenance services based notices sent out by the service provider. Having a system that could anticipate what parts would be needed for the upcoming days based on those scheduled future maintenance services facilitates the service provider in making sure they have proper and sufficient inventory. In addition to these systems not allowing a service provider to better budget for parts, these systems disadvantageously do not allow a service provider to budget and allocate units of labor from the technician based on the scheduled future maintenance. This leads to situations where the service provider under-schedules the facility because there are insufficient technicians/service bays, which in turn decreases profitability. Conversely, the service provider may over-schedule the facility, resulting in unhappy customers that have to wait or are told to return a different day and, in fact, may not return at all.

Therefore, a need exists to overcome the problems with the prior art as discussed above.

### SUMMARY OF THE INVENTION

The invention provides a system and method for managing vehicle maintenance information and, more particularly, relates to a vehicle maintenance system that utilizes information obtained from a vehicle owner and a vehicle service provider to alert and educate the vehicle owner and the vehicle service provider about recommended maintenance scheduling, specific vehicle parts and repair requirements, vehicle diagnosis information, vehicle service history, real-time inventory management, vehicle maintenance costs, and scheduling of vehicle owners for vehicle maintenance at the maintenance facility.

It is therefore a general objective of the present invention to utilize technology such as, but not limited to, texting, email, instant messaging, internet, USB devices, cable, telephone calls, and a real-time vehicle communication device to alert the customer and the vehicle service provider of information pertinent to the vehicle, and maintenance and parts recommendations. Further, the system may coordinate the vehicle's maintenance information with the vehicle service provider and the vehicle owner through the use of various communication technologies and novel methods.

Another objective is to efficiently update, record, and access the vehicle's maintenance history through the internet or at the vehicle maintenance provider facility. The system also provides a vehicle service provider with maintenance information directly from a manufacturer of a particular vehicle, to permit the vehicle maintenance provider to determine the necessary maintenance time periods and mileages for a given vehicle. The system may then alert a vehicle owner of needed maintenance by graphically displaying recommended maintenance items and dates.

Still another objective is to facilitate the vehicle owner's ability to maintain the vehicle by recording statistics from the vehicle and taking the vehicle for maintenance at the recommended times.

Yet another objective is to create a more efficient inventory management method and system by utilizing real-time technology, wherein the sales associate and the technician may change and view inventory simultaneously.

In summation, embodiments of the present invention may provide: 1) a method and system for registering, documenting, and monitoring at least one vehicle with a vehicle maintenance provider; 2) a method and system for recording maintenance and parts information for a vehicle; 3) a method and system for a customer, a sales associate, and a technician to receive real-time maintenance and parts related information about the vehicle; 4) a graphical, real-time maintenance interval schedule for alerting a customer, a sales associate, and a technician about recommended scheduled maintenance in the present or the future; 5) an appointment setting system that provides a unique time slot for each customer to ensure that maintenance work will not be overbooked at the maintenance facility; 6) communication methods for coordinating a vehicle's maintenance information between a customer and a maintenance facility; 7) a digitized service record for archiving all maintenance and parts used for the vehicle; 8) technological tools for the customer and/or the sales associate and technician to record the vehicle's maintenance information; 9) a method and system for a sales associate and a customer to visually inspect the vehicle to identify potential maintenance and parts needs, and record the findings on a portable electronic device, whereby the information obtained becomes a part of the vehicle maintenance history and is accessible by the technician; 10) an interface displaying graphical vehicle hot spots of a vehicle for identifying parts and maintenance information associated with those hot spots; 11) a multiplicity of digitized vehicle owner's manual for different makes and models; 12) a method and system for performing inventory management, including product searches, product transfer between facilities, deck counts, product adjustment, product returns, and inventory scans; 13) a method and system for generating a fast and accurate price quote for products and services; 14) a technician dashboard feature for providing the technician with information pertaining to the vehicle, such as maintenance history, parts requirements, and vehicle specs; 15) a method and system for assisting a sales associate with incoming phone calls by providing the sales associate with customer information, real-time vehicle maintenance history, customer history, maintenance and parts information, and a script to follow; 16) a method and system for reviewing, verifying, and printing a work order from either a point of sale display, a portable electronic device display, or the internet; 17) a method and system for monitoring and rewarding preferred customers with a national accounts approach, a P-Card, and a loyalty points system; 18) a method and system for monitoring and rewarding the sales associate and the technician; 19) a real-time vehicle communication device for monitoring the vehicle's driving and maintenance status, and then recording the information in a vehicle maintenance data storage site; 20) a virtual symptom selector that incorporates video and audio for assisting a vehicle owner identify vehicle problems; 21) a method of extrapolating scheduled maintenance from manually inputted information and updating the owner with alerts by mail, text, email, and telephone calls; 22) a computer system that has capabilities to extrapolate expected maintenance needs based on automatically relayed technical data from the vehicle, and then alert the customer about scheduled maintenance visits; and 23) a real-time inventory management system that allows for product transfer, product search, deck counts, adjust items count, returns, and inventory scans.

Whereas the invention has been shown and described in connection with the preferred embodiment thereof, many modifications, substitutions and additions may be made which are within the intended broad scope of the described invention(s). For example, customers may automatically be added to the remote maintenance data storage site so that a full maintenance history may be accessed at any time. Similarly, the remote maintenance data storage sites for various maintenance facilities may be networked to permit the vehicle information to be transmitted throughout the country, and made available to other maintenance facilities.

Although the invention is illustrated and described herein as embodied in a system and method for managing vehicle maintenance information, it is, nevertheless, not intended to be limited to the details shown because various modifications and structural changes may be made therein without departing from the spirit of the invention and within the scope and range of equivalents of any filed claims. Additionally, well-known elements of exemplary embodiments of the invention will not be described in detail or will be omitted so as not to obscure the relevant details of the invention.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification may conclude with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a flow chart representing an overview of a walk-in customer's interactions with a sales associate operating under a maintenance system according to the present invention;

FIG. 2 is a flow chart representing an overview of the maintenance service process from check-in to check-out from the perspective of a customer, a sales associate, and a service technician according to one embodiment of the present invention;

FIGS. 3-6 are screen shots of scheduling features of the system in accordance with embodiments of the present invention;

FIGS. 7-9 are screen shots of obtaining and viewing current and previous service, customer and vehicle information in accordance with embodiments of the present invention;

FIG. 10 is a screen shot a user interface of the system showing the customer and the customer vehicle information history in accordance with one embodiment of the present invention;

FIG. 11 is a screen shot representing a user interface to perform and view current and past vehicle walkarounds in accordance with one embodiment of the present invention;

FIGS. 12-16 are depictions of a portable electronic device used in the system by a maintenance service provider to facilitate in the walkaround or check-in process in accordance with embodiments of the present invention;

FIG. 17 is a flowchart representing a query process used in system when selecting a tire in accordance with one embodiment of the present invention;

FIGS. 18-22 are screen shots representing various product/part selection and replacement user interfaces of the system in accordance with embodiments of the present invention;

FIGS. 23-24 are screen shots reviewing and summarizing product/service purchases in accordance with an embodiment of the present invention;

FIG. 25 is a screen shot of an incoming phone call associating the phone number with a customer vehicle and identification information in accordance with one embodiment of the present invention;

FIG. 26 is a screen shot of product/service purchase user interface in accordance with one embodiment of the present invention;

FIG. 27 is a screen shot of the vehicle evaluation user interface in accordance with one embodiment of the present invention;

FIG. 28 is a screen shot the inventory management user interface in accordance with one embodiment of the present invention;

FIGS. 29-31 are screen shots of the online E-Garage user-interface in accordance with embodiments of the present invention;

FIG. 32 is a depiction of a portable electronic device operable to scan and input customer and vehicle information in accordance with an embodiment of the present invention;

FIG. 33 is a screen shot of the system representing maintenance service schedules and associate sales of a particular service facility in accordance with an embodiment of the present invention;

FIG. 34 is a screen shot of a scheduling feature of the system in accordance with one embodiment of the present invention;

FIG. 35 is a screen shot of the vehicle evaluation/work order user interface in accordance with one embodiment of the present invention; and

FIG. 36 is a block diagram of an exemplary circuitry of a system and method of communicating information between the customer and the business in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient system and method for managing vehicle information, including maintenance information. The system of maintaining and updating end user data can be generally classified into two separate categories. The first being a user's interactions and information exchange while the user is physically located at the vehicle service provider's facility and the second being a user's interactions and information exchange with the vehicle service provider's facility while the user is located at a remote location, i.e., through the internet.

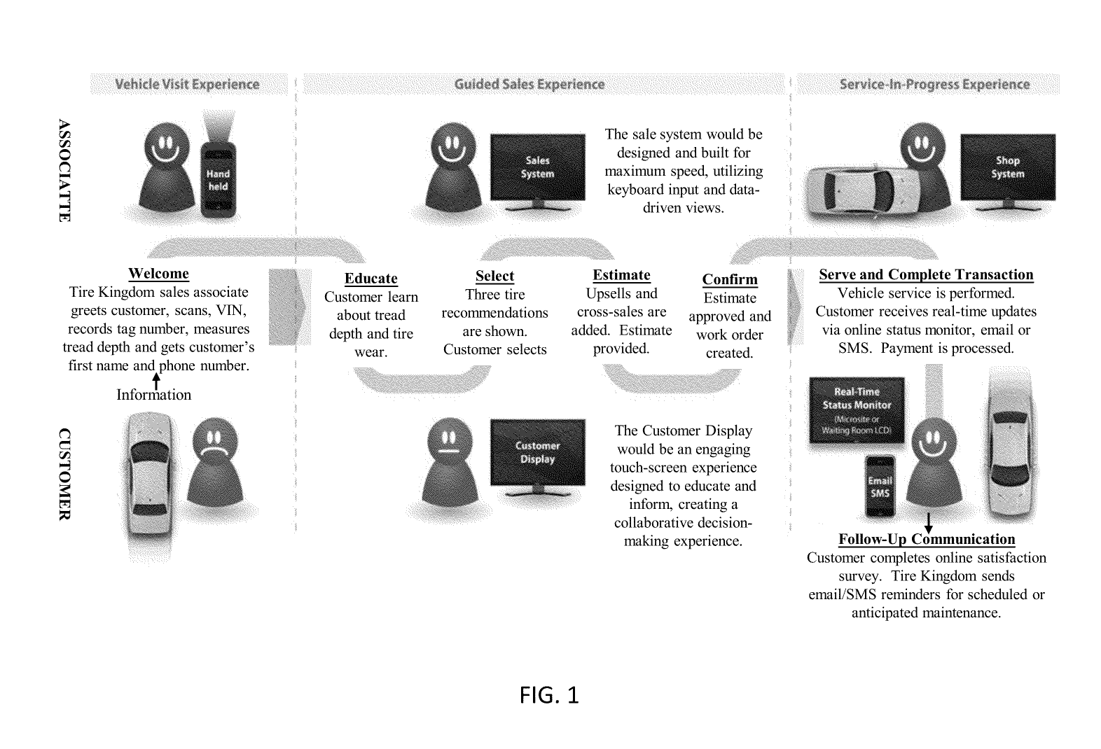

With reference now to FIG. 1, an exemplary flow chart of a walk-in customer's interactions and communications with a sales associate are shown, in accordance with one aspect of the present invention. FIG. 1 shows several advantageous features of the present invention, but, as will be described below, the invention can be provided in many combinations of features and components, and varying numbers and functions of the components now known or developed in the future. The system shown in FIG. 1 may include the initial step of entering vehicle identification data into a computer system. The computer system may be portable and operable, for example, an IPHONE, IPAD, or the like, to scan and receive the user's personal identification and vehicle identification data. This allows the vehicle service provider to input information outside the traditional setting of the inside of the facility. The mobility further promotes user/customer interaction as the user is able to view and assist the associate in properly identifying the user's issues with the vehicle. In addition, by scanning the vehicle or allowing the technician to obtain identifying information from the vehicle, rather than the driver, the information will be more reliable. The technician is also more likely to identify other areas of concern that wouldn't otherwise be apparent from within the facility.

The computer system may include a database with vehicle maintenance data, a processor for processing the vehicle identification data and selecting appropriate vehicle maintenance data for the owner's vehicle, a monitor for displaying the selected vehicle maintenance data, and a user-friendly interface. If the user is a return customer, the computer system may notify the associate of all previous repairs and maintenance, which further assists the associate in properly identifying the issues of the vehicle.

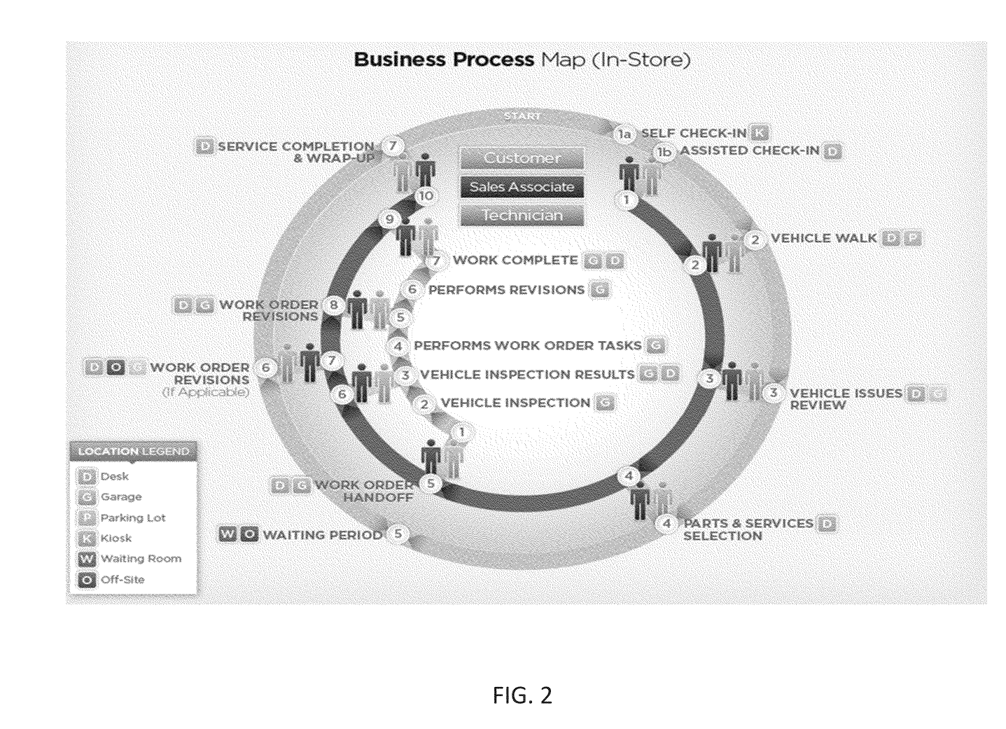

The process, as shown in both FIGS. 1 and 2, initiates at the service provider's facility, at the time the customer requires maintenance or has an inquiry related to the vehicle. FIG. 2 illustrates the additional interaction and communication with a technician of the vehicle service provider. The customer is initially greeted at the maintenance facility. The customer's questions are addressed by the sales associate, who also educates the customer about any maintenance related questions. A walk around of the vehicle may be performed to identify any maintenance requirements. After the appropriate maintenance is decided upon, a selection of parts and maintenance is decided upon. The cost for the maintenance is then quoted. Next, the maintenance is confirmed and a work order is generated. The maintenance is performed by the technician. After the customer is satisfied with the maintenance the transaction is completed with payment for services and parts. Afterwards, the sales associate follows up with the customer to verify satisfaction with the maintenance work performed and schedule a future maintenance visit.

The customer, the sales associate, and the technician each play an important role in the method and system for managing the maintenance information. As shown in FIG. 2, the customer initially arrives at the maintenance facility and may also check-in at a point of sale display, for example a kiosk. The check-in involves inputting personal information and vehicle information. The method for managing vehicle maintenance information recognizes the customer and vehicle history, and displays the appropriate sales and marketing information pertinent to the vehicle. The sales associate is available to assist the customer during the check-in process. As briefly mentioned, the sales associate may utilize a portable electronic device to scan or input the vehicle's identification number, identify damage to the vehicle, view vehicle maintenance history, check for parts and prices, and generally, expand the vehicles maintenance history.

The sales associate and customer then review all potential maintenance and parts recommendations. The sales associate selects and inputs the agreed upon maintenance and parts into the portable electronic device or possibly the point of sale device, both of which are operatively connected to a maintenance data storage site. In one embodiment, the data storage site is made up of one or more data structures that may be located on a network that is communicatively coupled with all locations of the service provider. In other embodiments, the data storage site is made up of another storing medium and remotely stored and accessible through an internet protocol or the like.

Next, the sales associate generates, verifies, and prints out a work order. The customer then waits in a waiting area or leaves the maintenance facility while the maintenance occurs. Subsequently, the sales associate delivers the work order and vehicle to the technician to commence the maintenance. The technician inspects the vehicle and the work order. The technician has access to the vehicle maintenance history, and updates it as the vehicle maintenance commences. If work order revisions are necessary, the sales associate and the customer are consulted. The technician performs the maintenance revisions to complete the maintenance. After maintenance is complete, and the customer is satisfied, the customer pays for the maintenance and parts. The sales associate may later follow up with the customer to verify satisfaction with the maintenance and to also schedule a future vehicle maintenance visit.

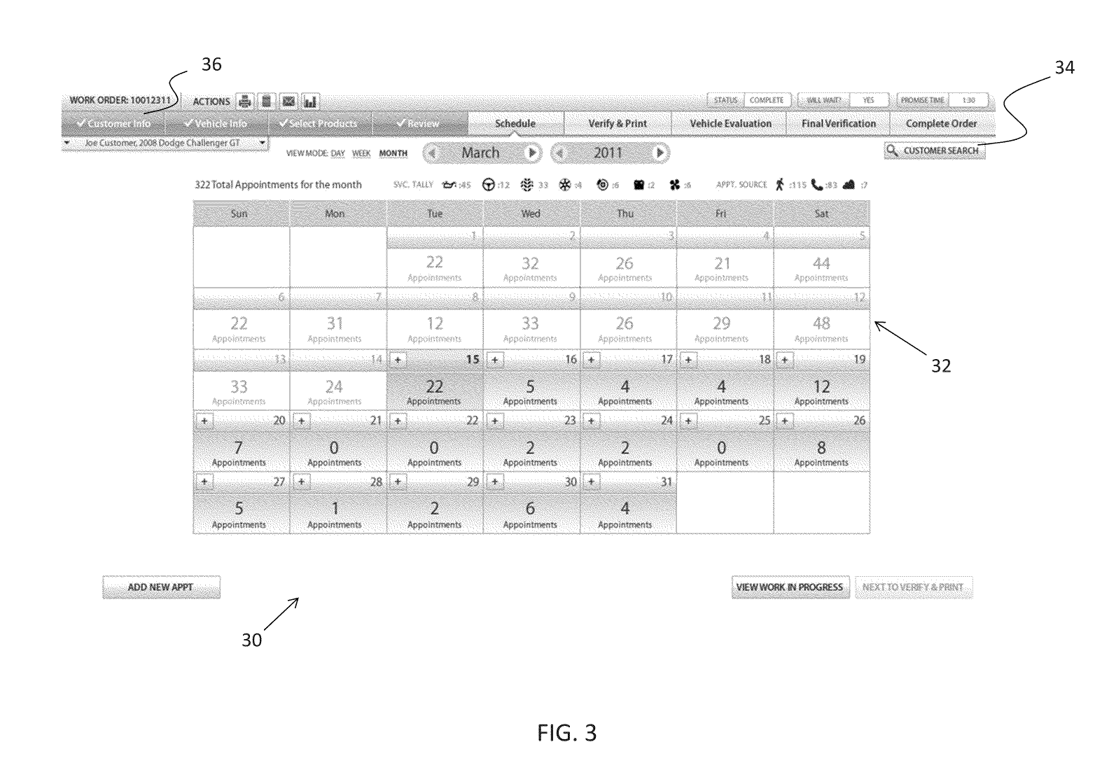

FIG. 3 illustrates a screen shot of the computer interface 30, representing one step in the check-in process that includes scheduling the customer for vehicle maintenance. This interactive and user-friendly scheduling calendar 32 allows the sales associate or the customer to more easily view the possible date and time slots for vehicle maintenance when no other vehicle is scheduled. Although this screen and options associated along with it are generally for the benefit of the sales associate, alternative scheduling calendars 32 may also be provided to the customer to select his or her own service appointment time, e.g., at the kiosk or online. This calendar 32 may have certain links or options removed, such as the “customer search link” 34. The scheduling calendar 32 can be viewed by day, week, and month, and can also be sorted and viewed based on the type of services being performed and based on the referral source. This advantageously allows for the service provider to have valuable information for market research and allows the service provider to forecast estimated employee hours and parts needed for the week or month. The system may also allow for the associate and/or customer to view the work currently being done to project a wait time. In other embodiments, the system may forecast a projected time based upon the type work being performed, possibly comparing the type of service asked to be performed with a technician's average time to complete that service or similar service. This may be based on a personal completion times or company averages for that particular job. The estimated completion may be also communicated/updated to the customer when he or she schedules the service.

The associate may simply click on the day of the month to schedule a customer's appointment for maintenance/repair. It can also be seen how selecting a specific date will send the associate, or in some cases, the customer, to a day view menu where the complete maintenance schedule for the maintenance facility is available. Selecting the “+” button allows the user to add an additional vehicle to that date's maintenance schedule. These options may also include the date, time, and the specific bay in the maintenance facility where the maintenance occurs, technician, and means by which the customer initiated the maintenance visit. As will be discussed below, one example of the present invention is applied to scheduling and user interaction over the internet, which may include managing and recording the vehicle maintenance information through the maintenance service provider's data storage site, whereby the date, time, maintenance bay, and even the technician may be reserved. As such, the customer and service provider are guaranteed scheduled maintenance without conflict, and the technician work hours are managed more efficiently.

The computer interface 30 may include a tab or link 36 where the associate or customer may directly input information in the database of information. This information may be inputted through a keyboard or through a touch screen of a portable device or other device. In the alternative, a customer already in the maintenance data storage site may be selected from an existing customer list. The scheduling calendar 32 may be accessed at the particular maintenance facility where maintenance on the vehicle is to occur, e.g., at the point of sale display that is viewable by the customer, the sales associate, and the technician. The customer search link 34 allows a previous customer or user to be searched by their name, company, and phone number for example. When the customer is found, all previous and future maintenance dates may appear graphically on the calendar.

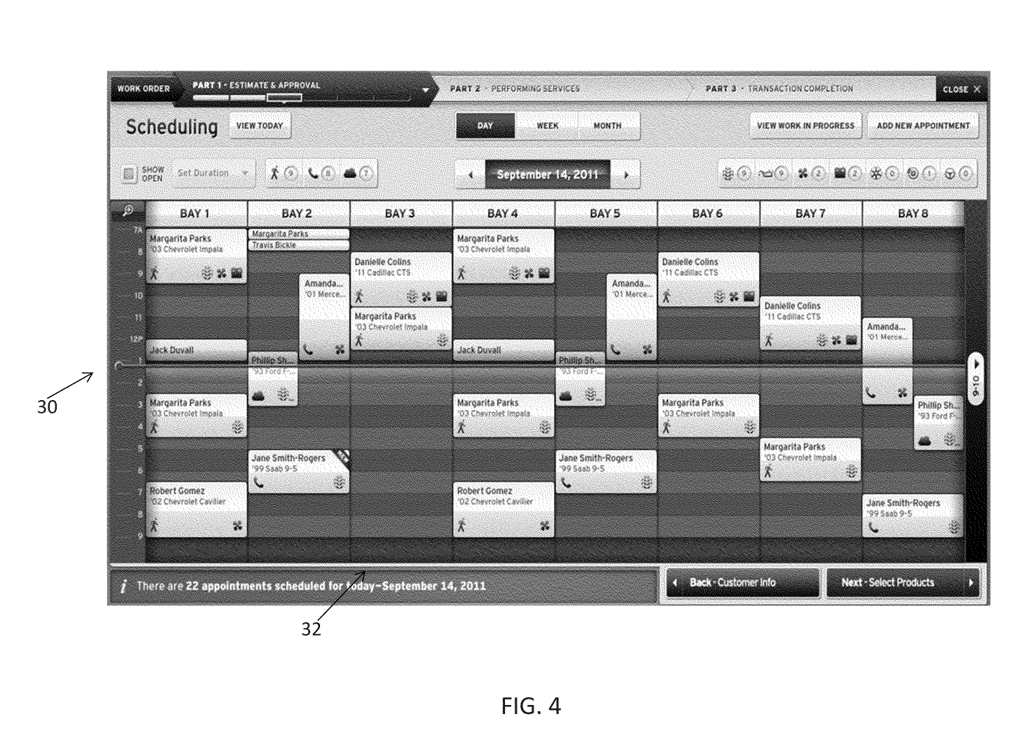

As shown in FIG. 4, an alternative view of the calendar 32 is represented with time intervals spread throughout the day at each bay of the service facility. The calendar 32 may also be viewed to represent intervals of scheduled maintenance throughout the week that may also reference the amount of appointments for each day. At this juncture, an associate or technician may change the estimated duration of the service or repair and schedule services at open intervals of time. All information imputed into the interface 30, including the scheduling calendar 32, may automatically appear on the subsequent work order generated for the desired services to be performed. In certain embodiments, the interface 30 is in communication with a telephone system or other system, that may automatically dial the user/customer when the services are finished or if the associate has additional inquiries directed toward the customer. In other embodiments, the click of a certain link on the interface 30 will text or otherwise notify the customer electronically.

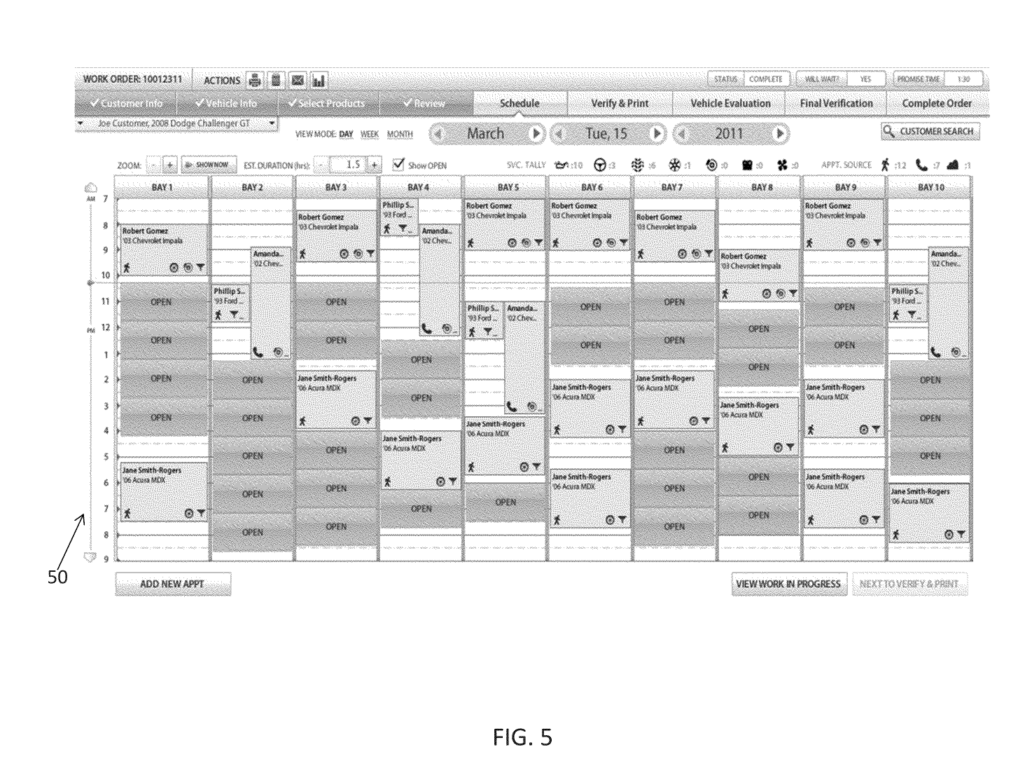

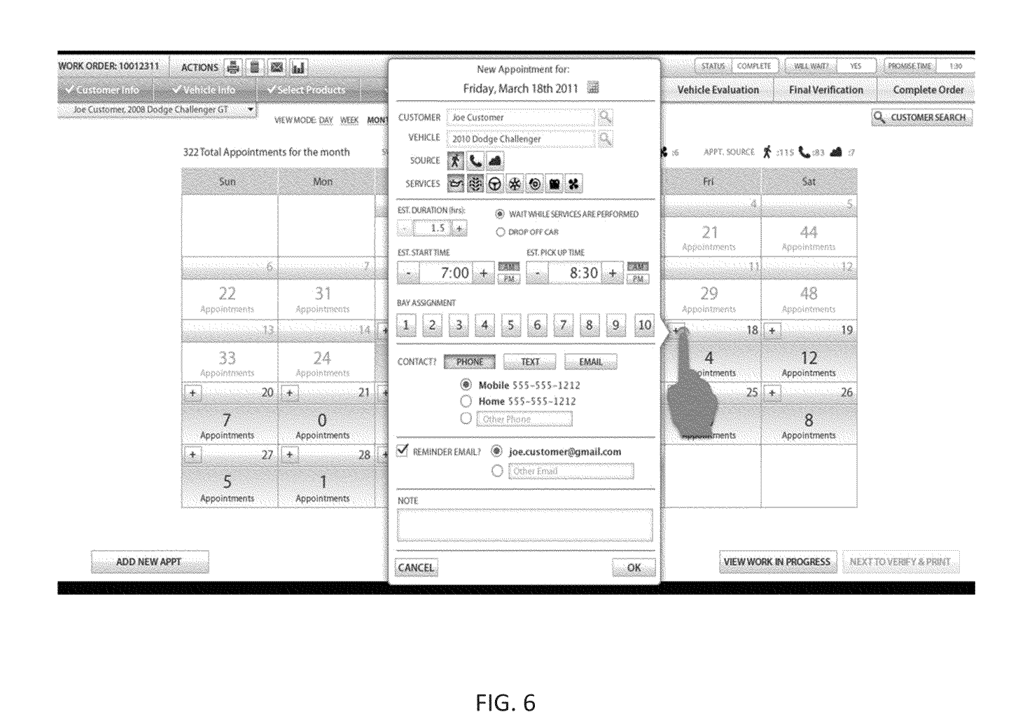

The user may select a “View Mode,” which is a graphical representation of each customer for a seven day period, along with type of vehicle, time, technician, and expected maintenance. In another example shown in FIG. 5, the calendar 50 may also be displayed by day, associating the work orders by each work bay, by technicians, or type of job. In this manner, the sales associate or technician can efficiently identify the outlook for a specific date thereby increasing efficiency. In one preferred embodiment, every customer, vehicle, and maintenance scheduled into the scheduling calendar automatically appears on the subsequent work order. A graphical representation of the occupied and available maintenance times during a specific date is further shown in FIG. 5. FIG. 6 represents a screen shot of a user interface of the system, which is operable to schedule appointment times for a particular vehicle maintenance work order.

In an alternative embodiment, the scheduling calendar alerts the customer to recommended maintenance. Additional information that may be included in the scheduling calendar may include, but not be limited to, whether the vehicle will be dropped off, whether the customer would like to be notified upon completion of the maintenance, and the best means for contacting the customer. Once entered, this customer information is archived in the maintenance data storage site and may be utilized for future maintenance visits. In a further embodiment, the specific information and appearance of a scheduled vehicle appears upon clicking the vehicle on the calendar. An alternative embodiment of the calendar may numerically signify the amount of vehicles being maintenance during a particular date, and show a graphic representation of each type of vehicle on the calendar date. Additional maintenance visits may be scheduled by clicking the “New Work Order” button located in each column of a date.

In a further embodiment of the present invention, for each vehicle that requires maintenance, the most recent maintenance is colored with bright red and flashes on and off on the maintenance date, so as to alert the customer of the need for maintenance. Any prior maintenance visits are provided with different colors and do not flash. It should be noted that the use of a flashing alert may occur if the vehicle has traveled a distance beyond the minimum requirement for that particular service item. In an alternative embodiment, audio and video may also be utilized on the scheduling calendar to alert for scheduled maintenance.

In an additional embodiment, the computer system may calculate an extrapolated maintenance date based on vehicle mileage and last maintenance visit, and automatically text or email the customer prior to the scheduled maintenance date. For example, but not limited to, three-quarters of the way between the last maintenance visit and the next scheduled maintenance visit, the customer may receive a text message requesting the mileage for the vehicle. Based on the mileage input, the next maintenance date can be extrapolated and confirmed by the computer system. However, other parameters may be factored in determining the extrapolated maintenance alert, such as, but not limited to, type of vehicle, warranty specs, and driving history of the customer. The extrapolated maintenance alert is a beneficial feature if the vehicle drives extended miles or if the customer is extremely busy and is not mindful of providing maintenance to the vehicle or family member's vehicles. In this manner, the vehicle will not exceed the life of its fluids, filters, tires, or other maintenance components. This embodiment may also be preempted by the sales associate if certain warnings or vehicle damage is noted during the maintenance visit.

Those skilled in the art, in light of the present teachings, can appreciate that scheduling may further be enhanced with a real-time vehicle communication device installed in the vehicle provides remote vehicle maintenance information. The vehicle communication device operatively attaches to a vehicle processor, e.g. ECU, which in one embodiment, is located under the steering wheel. The vehicle communication device records and transmits the vehicle's driving parameters such as, but not limited to, speed, number of trips, driving hours, mileage, amount of braking. This recorded information may then be transmitted wirelessly through the network of a customer's mobile device, such as a phone. As such, the customer would plug there phone into the vehicle processor, which would then transmit the information to the service provider. In further embodiments, a transmitter may be plugged into the processor, that is communicatively coupled to the mobile device, through Bluetooth for example, and then the information is uploaded to the remote data storage site. Regardless the embodiment, vehicle information may be transferred to the data storage site without manual input from the user. This efficiently and effectively transfers pertinent vehicle information to the service provider without the user having to continually monitoring and updating the information.

The vehicle maintenance information is efficacious for monitoring the vehicle's driving and maintenance status, and then transmitting the information to the remote vehicle f storage site. The recorded vehicle driving data then becomes part of the vehicle maintenance history. In a further embodiment, the maintenance facility monitors the data in the remote vehicle maintenance data storage site to recommend maintenance and parts. Certain driving behavior by the customer also trigger a maintenance scheduling alert from the maintenance provider to the customer. For example, but not limited to, if the customer utilizes the brakes often and heavy, an alert for brake maintenance and brake pad promotions may be texted or emailed to the customer.

In an alternative embodiment, a software application on the customer's personal computer may monitor the vehicle for potential maintenance problems and then record the subsequent vehicle information. The customer then remotely transmits the vehicle information to the remote vehicle maintenance data storage site. The maintenance provider, who has access to the remote vehicle maintenance data storage site may then schedule a maintenance visit or recommend solutions to the maintenance problem. The customer may also arrive at the maintenance facility and display the maintenance problem to the sales associate and the technician directly from a personal computer or portable electronic device. For example, but not limited to, if the “Check Engine” light appears, the customer may transmit vehicle information from the vehicle processor to the personal computer. The software application then analyzes the Check Engine issue. The customer then transmits the software application's analysis to the maintenance provider. The customer receives an online diagnosis from the maintenance provider in a short period of time, even prior to arriving at the maintenance facility for servicing. This is beneficial for those users that may not have the time or money to bring their vehicle in for service, but still desire to know if their vehicle is safe to drive. As the service provider already has the vehicle information, a user is prone to bringing the vehicle to the service provider as opposed to another facility. This facet of the novel maintenance service system also generates customer good will as the service provider continually updating and monitoring potential safety of the customer while in the vehicle.

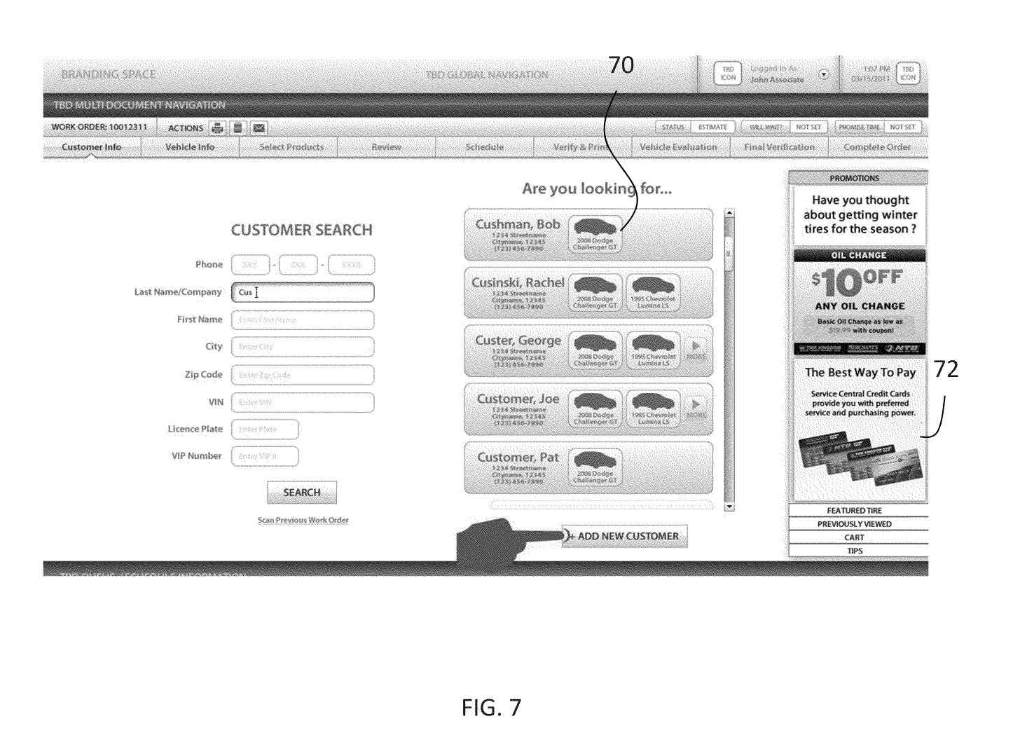

In one embodiment of the method and system for managing vehicle maintenance information, the sales associate and/or technician log into a computer by the entry of an ID number or the like. The customer may also locate his or her information through a customer search using identifying information such as VIN, license plate number, VIP card number, etc., but other customer information may not appear. Once the system for managing vehicle maintenance information is up and running, a customer information look-up screen, shown in FIG. 7, appears on the point of sale display, portable electronic device display, and/or internet display. The customer information screen requires the input of customer information in order to access a customer and vehicle maintenance history.

FIG. 7 includes a plurality of windows and text boxes into which customer information may be inserted in a variety of fashions. For example, a customer name window permits direct input of a customer name through a keyboard by clicking the “Add New Customer” button. In the alternative, a customer already in the maintenance data storage site may be selected from an existing customer list. In a further embodiment, promotions that may be pertinent to the customer's maintenance history appear on the display once the customer is identified. This may appear at the point of sale display to facilitate the selection of products by the customer, or at the screen visible by the sales associate to market and sell certain products.

In a further embodiment, clicking a graphical representation 70 of the customer's vehicle retrieves the vehicle maintenance history from the maintenance data storage site and causes the information to appear on the display. In one embodiment, a variety of inquiries appear on the customer information screen, such as updates for address and phone number and requested maintenance and parts. In this embodiment, additional detailed customer information may be viewed by clicking a “View Customer Info” button. In one embodiment in the customer information window the customer may apply for credit by clicking the “Apply For A Credit Card” button 72. Text boxes may appear when the customer applies for credit with the vehicle maintenance provider that allows the customer and/or associate to input the required information for a credit application.

In one embodiment, the customer information window permits access to customers who have a national account with the maintenance provider. The maintenance provider offers a national account for the customer, often a company with a large fleet of vehicles. In additional embodiments, national accounts may provide the customer with advantages such as volume discounts, extra warranty coverage for parts and maintenance labor, easy credit, and prizes from a plurality of maintenance provider facilities in different states. The customer decides the maintenance and parts parameters for each vehicle that is covered by the national account. In this manner, the customer may more closely monitor and control a budget for the vehicle maintenance.

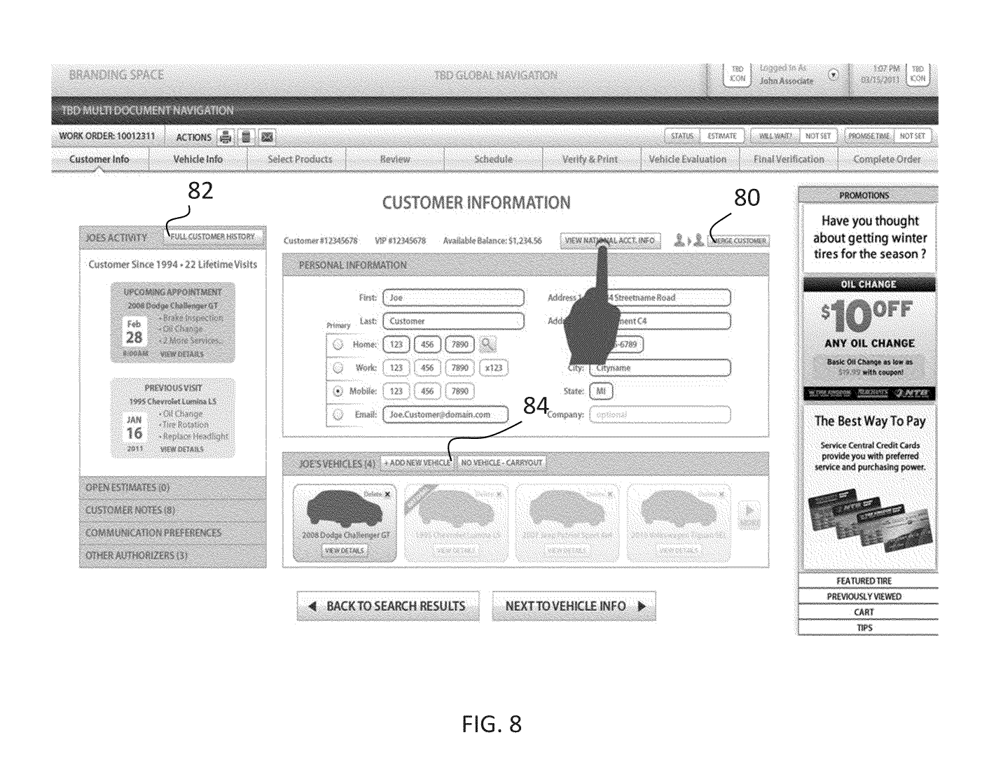

FIG. 8 illustrates how the customer who has a national account, or wishes to obtain a national account may be accommodated by clicking the “View National Account Information” button. In one embodiment additional customer information is entered into text boxes to register the customer with a national account. A plurality of windows and text boxes may display the parameters and benefits of a national account. A graphical representation of the customer, such as a company logo may display to identify the customer. Clicking the appropriate company logo allows access to the vehicles, maintenance services, and parts covered by the national account. The fleet provider may also be identified to obtain further customer and vehicle information. FIG. 8 also illustrates how multiple vehicles may be graphically associated with each customer account. This advantageously allows a one user, i.e. customer or associate, to view service history, millage, and other information about multiple vehicles from a single screen. Further, upcoming services and notes from previous services may also be viewed from his screen. This is beneficial for the aforementioned fleet managers and for parents that desire to monitor multiple vehicles.

When a user of the system desires to create/update/cancel a national account a window may appear whereby a plurality of customer and vehicle information may be entered/updated. The information includes, but is not limited to, customer location, company name, vehicle identification, vehicle maintenance requirements, and budget limits. In one embodiment, the national account is accessible anytime from the internet or the maintenance facility. Further, a specific vehicle in a fleet may be described, along with maintenance requirements and parameters. In further embodiments, the national accounts window alerts the sales associate and/or the technician that the desired maintenance or part is not regularly utilized by customer. In another embodiment, the maintenance facility must notify the national account customer that maintenance will be performed on the vehicle prior to commencing with the maintenance.

One alternative embodiment in the customer information window includes a plurality of customers who may be merged by clicking the “Merge Customer” button 80. This may be advantageous if the customers are family members, with one family member taking responsibility for vehicle maintenance for all the vehicles in the family. A list of the customers who are merging under one account may appear on the display.

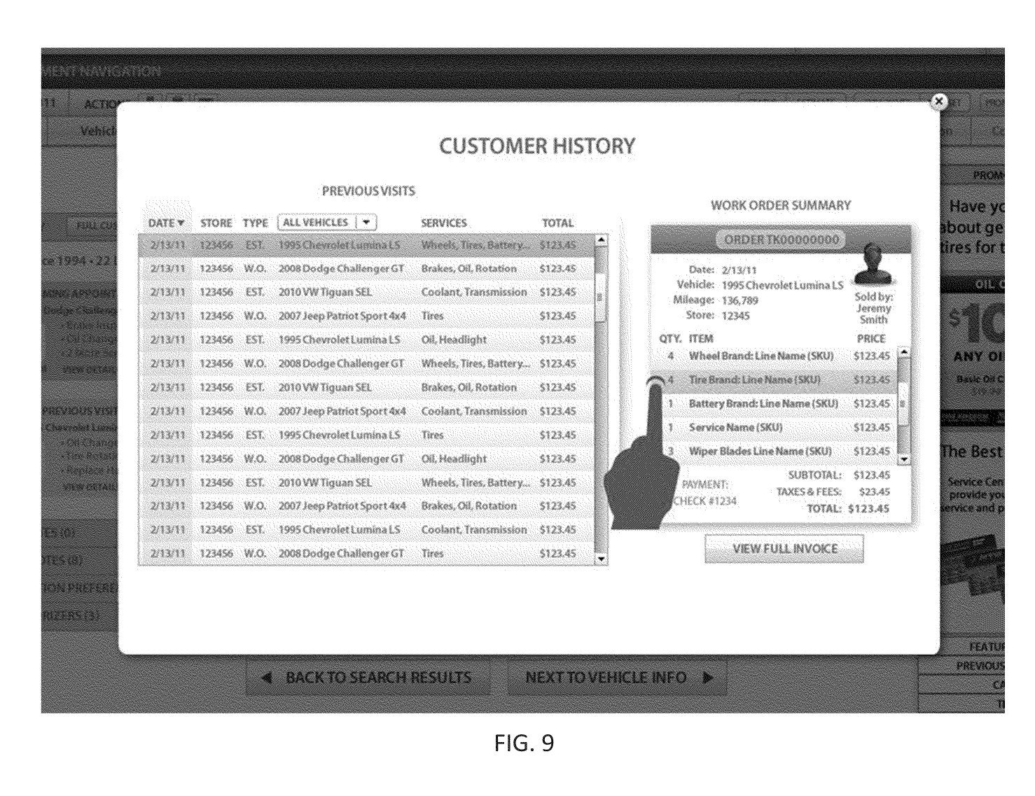

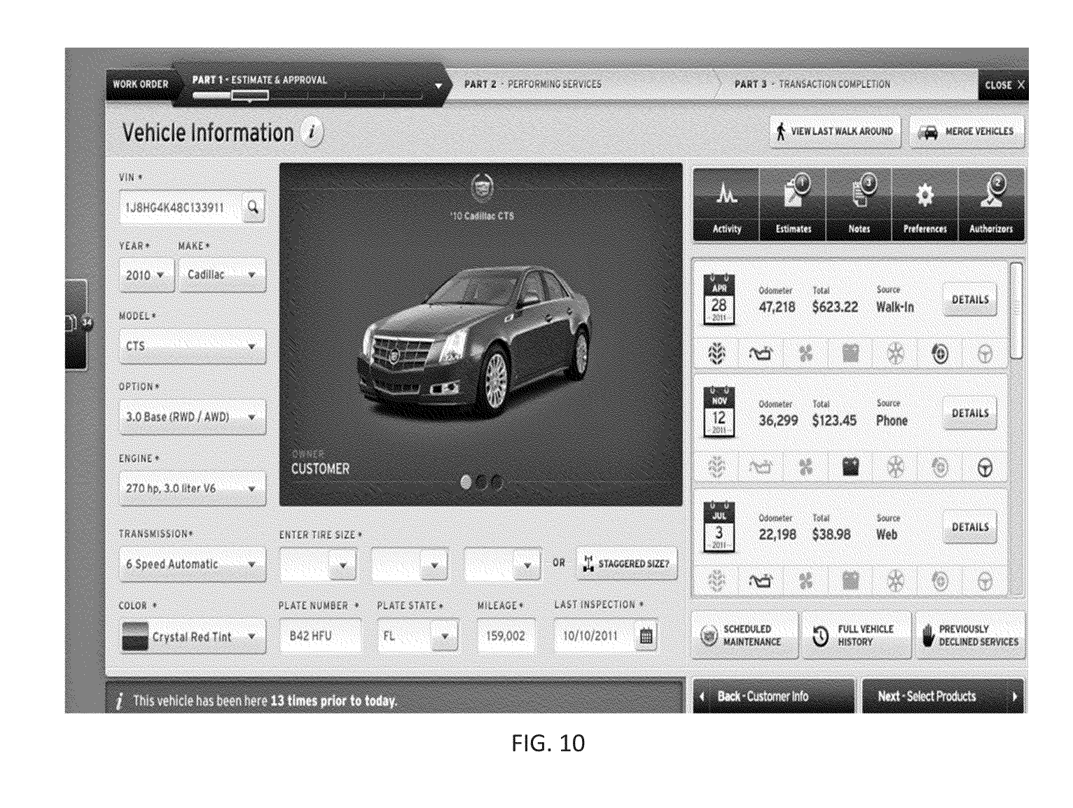

FIG. 9 illustrates one embodiment of the “Full Customer History” when accessed through the system's interface. The “Full Customer History” button 82 (shown in FIG. 8) may be clicked to display the complete customer maintenance history, including vehicle history. In one embodiment, the customer history includes all prior work orders or estimates issued by the service provider. In one further embodiment, an “Add New Vehicle” button 84 (shown in FIG. 8) in the customer information window may permit the sales associate, customer, or technician to include a different vehicle in the customer's information. Once this has been initiated, a vehicle information window appears. The selection process in the vehicle information window provides vehicle parameters such as, but not limited to, VIN number, make, model, year, color, tires, mileage, maintenance preferences, and part preferences may be selected, as shown in FIG. 10. Because most scheduled maintenance intervals are based upon the mileage of the vehicle, a mileage window is provided in the vehicle information window to remind the customer or sales associate of the vehicle's status.

In one embodiment of the system's user interface, shown in FIG. 10, a plethora of information relating to the customer and the customer's vehicle is shown in the form of a virtual “E-Garage.” As shown, all of the vehicle maintenance history is encapsulated and accessible from the E-Garage. From the E-Garage, the vehicle's scheduled maintenance, mileage, and editing options are available for the sales associate or technician to review and change. Although his E-Garage may be shown at the point-of-sale display or at the device used by the associate, it may also be accessible on-line, accessible by customer and/or the associate.

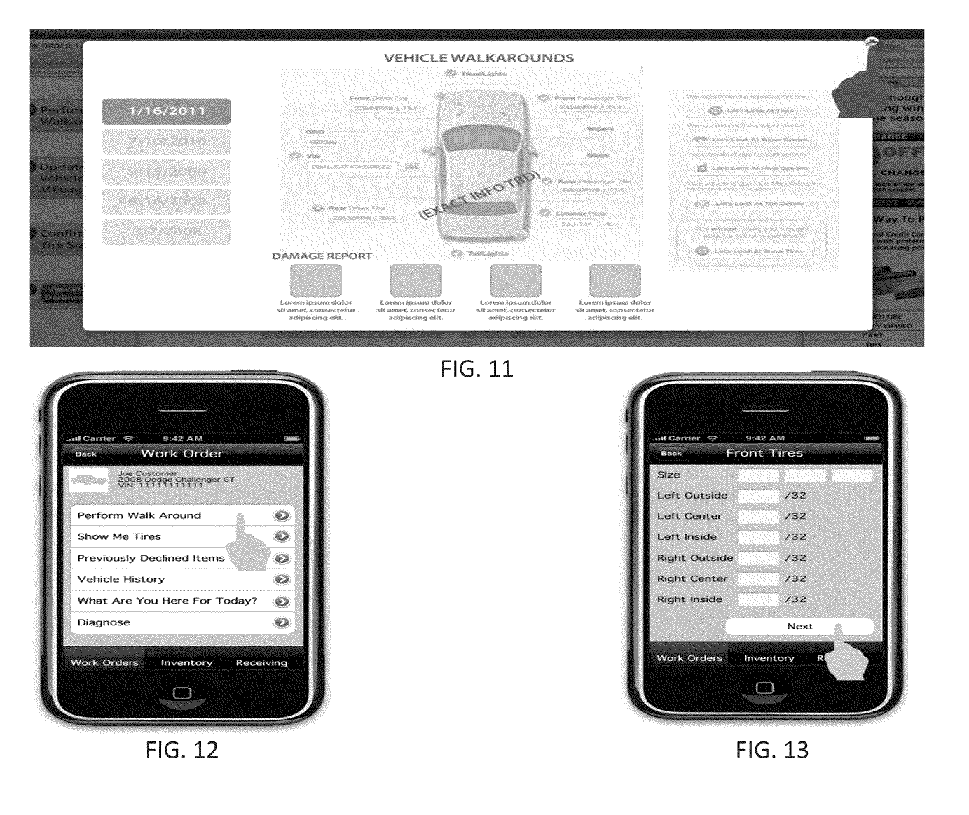

Once all of the vehicle and customer information has been inputted, a visual inspection of the vehicle involving the customer and the sales associate, referred to as a “walk around” may be initiated. From the point of sale display or the associate's mobile device, a “Walk Around” button, or any variation thereof, may be selected, and the vehicle history is displayed. One user interface of the system, reflected in FIG. 11, includes three main sections for the walk around window: a graphical depiction of the vehicle, a vehicle damage section, and a maintenance date and mileage section. FIG. 11 further represents a graphical depiction of the vehicle's walk around history. In one embodiment, after the customer and vehicle information have been entered and verified at the point of sale device, the sales associate and the customer perform a visual inspection of the vehicle to assess the condition of the vehicle, decide on necessary maintenance and parts, identify damage, diagnose problems, select services and parts, and obtain a price quote. The visual inspection is also part of the education process for the customer. The vehicle information obtained from the visual inspection may be inputted at the point of sale display, or the portable electronic device display. Of course, should the vehicle information be already inputted through the remote data storage, the associate would only need to confirm the virtual diagnosis or may not need to do a walk through, thereby expediting the check-in process.

In one embodiment, the sales associate utilizes a portable electronic device to perform the walk around with the customer. The sales associate may circle around the vehicle with the customer, discussing maintenance options, photographing vehicle parts and damage, tabulating maintenance and parts costs, deriving price quotes, forwarding maintenance information for the technician, and generally building the maintenance history of the vehicle. FIGS. 12-14 illustrate exemplary views of the portable electronic device as utilized for the portions of the walk around. One embodiment may require the sales associate to log in prior to accessing the walk around feature. Logging in is beneficial, in that it provides a record of which sales associate is assisting which customer and also documents the quantity of work performed by the sales associates. The sales associate selects the customer from a customer list. The customer list is accessed from the maintenance data storage site. The work order window includes numerous options including: “Perform Walk Around,” “Show Me Tires,” “Previously Declined Items,” “Vehicle History,” “What Are You Here For Today,” and “Diagnose.” All of these options are appropriate functions during the walk around. FIG. 13 illustrates the result of selecting the “Perform Walk Around” option. In one embodiment, the tires are initially inspected. Each tire is categorized according to tire tread depth on the left, right, center, outside, and inside of the tire. Measuring the tire tread depth (often in microns) during the walk around assists the sales associate and technician in determining whether a tire rotation, tire change, or tire alignment is necessary. In one alternative embodiment, prior to arriving at the maintenance facility, the customer checks the tire depth with a tire gauge obtained from the maintenance provider. The customer records the tire depth remotely into the data storage site for the maintenance service provider. If the tire tread that is recorded by the customer is unsatisfactory, the maintenance facility will automatically schedule the customer for a maintenance visit to address the tire problem. The system may also have the feature of sending one or more directed ads for tires, based upon the vehicle specifications and the customer's prior purchases. This advantageously relates the service provider's ability to provide replacement tires to the customer before the customer has a chance to shop around him or herself.

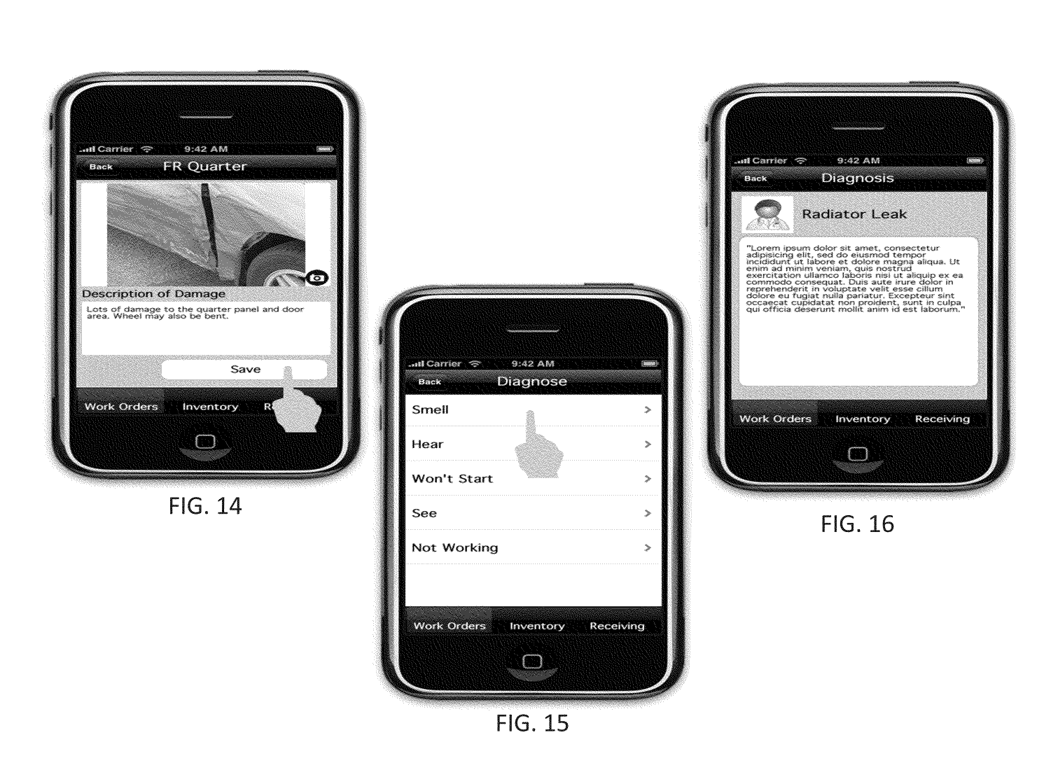

FIG. 14 represents an embodiment of one aspect of the invention utilizing a portable electronic device to document damage from the vehicle during the walk around. The general area of the vehicle is initially selected to indicate damage to a particular area of the vehicle such as, but not limited to, the front right fender, the rear bumper, and the like. A photograph may then be taken of the vehicle. Any future selections of the damaged area will display the photograph.

An alternative embodiment includes the “Show Me Tires” feature on the portable electronic device. In one embodiment, all prior tire types and sizes purchased by the customer display. These tires indicate the customer's preferences. In an alternative embodiment, any tires that are being promoted by the vehicle maintenance provider display. A further embodiment may include the “Previously Declined Items” feature. By having access to items that the customer declined, the sales associate can provide more efficient service to the customer. Or perhaps the sales associate may inquire why the customer refused the item, thereby overcoming the customer's objections in subsequent attempts.

While performing the walk around with the customer and the portable electronic device the sales associate may find it beneficial to have access to the vehicle maintenance history. Those skilled in the art, in light of the present teachings, can appreciate that the vehicle history may be real time, wherein the technician also has instant access to the vehicle history, even as the walk around generates changes in the vehicle history, for example, but not limited to, recent damage to the vehicle side door may alert the technician to check for tire alignment problems. As shown in FIG. 12, a “What Are You Here For Today,” or any variation thereof, feature on the portable electronic device is also available during the walk-in process. This feature provides future marketing and promotional material for the maintenance provider. The customer history is also expanded with this information. Each service and part is listed for selection upon entering this feature's window. In one embodiment, tires are selected. The sales associate is then directed to another window where further inquiries about the tire and vehicle are made. After answering the inquiries, a list of appropriate tires is displayed. As a tire is selected, the maintenance data storage site is notified/updated and the selected tire is removed from the inventory, which in one embodiment, is communicatively coupled to the data storage site.

FIGS. 15 and 16 demonstrate the “Diagnosis” feature of the portable electronic device walk around. This feature allows a layman who is not thoroughly familiar with vehicle maintenance, such as the customer or even the sales associate, to more easily diagnose problems with the vehicle. The diagnosis options are physical sensory detections that include, but are not limited to, “Smell,” “Hear,” Won't Start,” “See,” and “Not Working.” During the diagnosis process, a series of questions appear in various windows to better analyze the problem. For example, for the sensory detection “Smell” some of these inquiries include, but are not limited to, “What kind of smell,” “Where is smell emanating from,” and the like. FIG. 16 illustrates an exemplary final diagnosis, e.g., a radiator leak.

Those skilled in the art, in light of the present teachings, can appreciate that a “virtual” diagnosis feature is possible to implement from the portable electronic device, the point of sale display, or the internet display. In one embodiment, the virtual diagnosis includes, but is not limited to, audio and visual cues that assist a sales associate, a customer, or even the technician in diagnosing a maintenance problem. For example, but not limited to, a video on the portable electronic device display showing black smoke emanating from an exhaust pipe might visually appear similar to black smoke emanating from the customer's vehicle. If the customer or sales associate select the video of the black smoke, the “Diagnose” feature identifies a possible engine failure, such as damaged piston rings. Likewise, a specific rattling noise emanating from the front axle may be analogous to a rattling sound selected from the “Hear” feature, thereby identifying a potential CV joint failure. A further embodiment of the “Diagnosis” feature allows the customer or sales associate to access an internet search site from the internet, the point of sale, or the portable electronic device. Because of the myriad commercial and educational resources available on the internet, the internet search site may be efficacious in assisting with diagnosis of the maintenance problem.

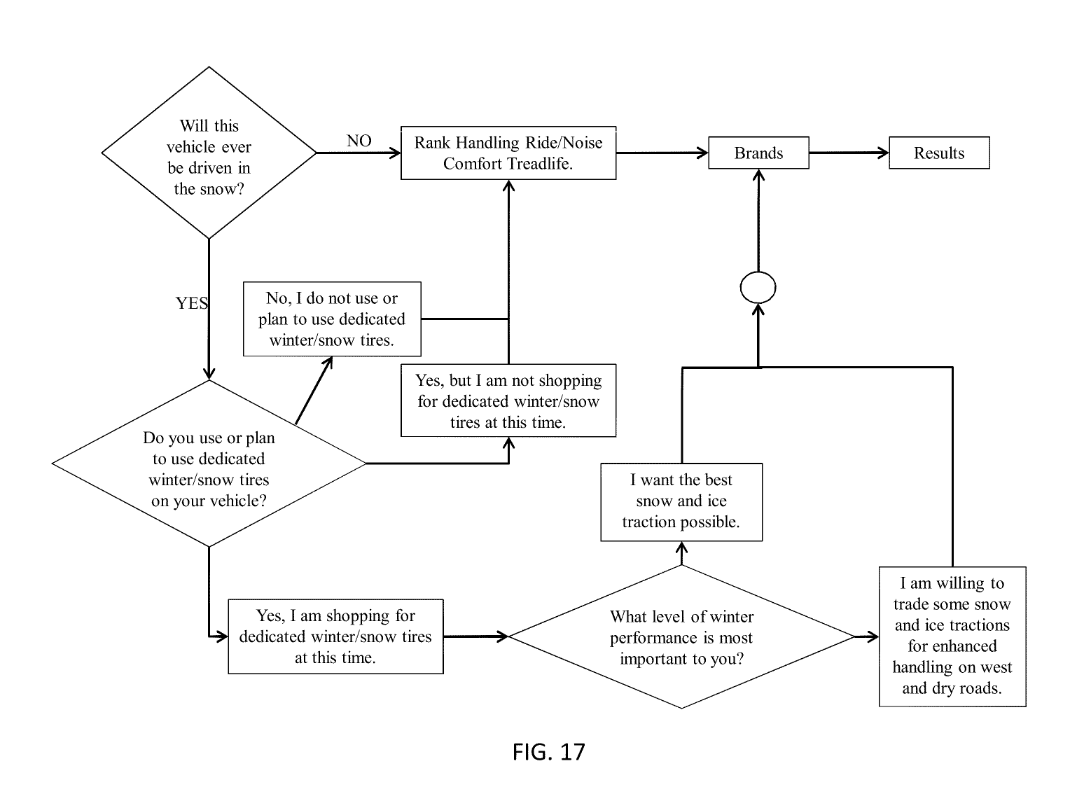

In a further embodiment, the method and system for managing vehicle maintenance information provides a dynamic capability to select and purchase parts and service from the internet, point of sale display, and the portable electronic device. One embodiment provides a “Select Products” window. The customer, sales associate, or technician selects from the option, or types into the search text box the desired part or service. Some parts and services available for selection include, but are not limited to, tires, wheels, diagnosis, and tire adjustments. Upon selection of a desired part or service, the system provides a flowchart-style series of inquiries that refine the query to a final part or service appropriate for the vehicle and the customer. FIG. 17 is one embodiment of the inquiry process, whereby an appropriate tire is selected using the flowchart-style inquiries. The questions may include, but are not limited to, “Will you drive the tires in the snow?” and a ranking inquiry that lists a customer's preference for comfort, traction, and tire noise. By utilizing the customer's answers, the sales associate can recommend the most appropriate parts and service for the customer and the vehicle. The inquiries are typically graphically illustrated.

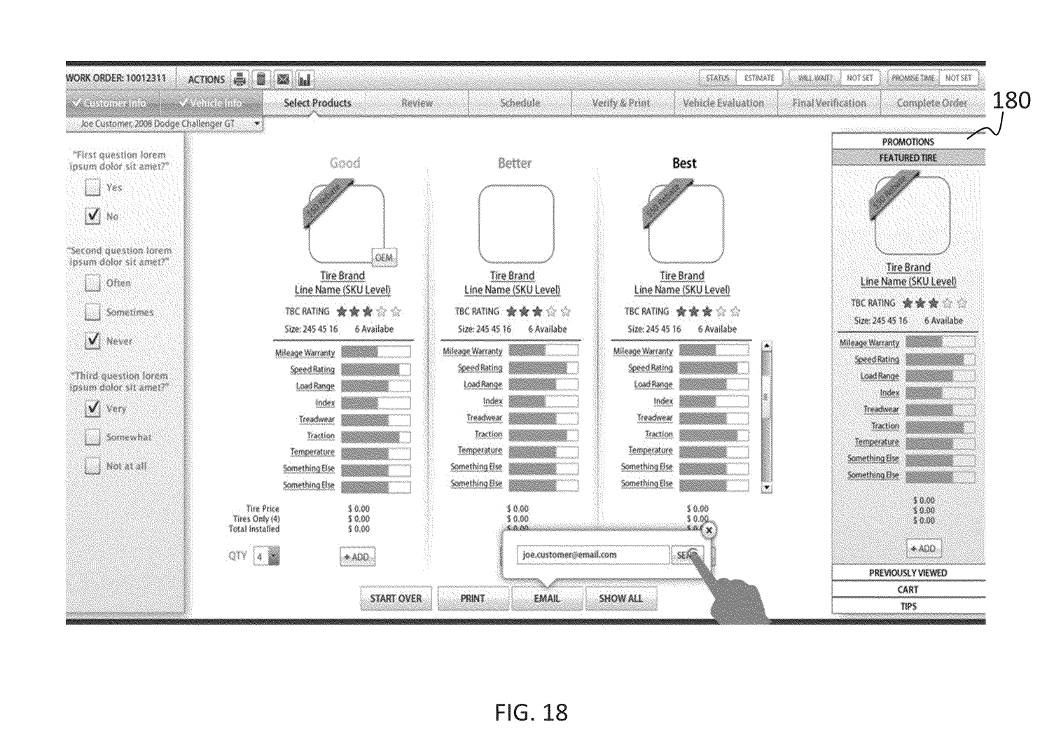

The method and system for managing vehicle maintenance information generally requires detailed information from the customer, in addition to the customer's vehicle. The series of questions may delve into questions about lifestyle and future plans to assist the customer in obtaining the most appropriate tires. The tires may then be segregated by quality, and recommended to the customer. One embodiment includes a tire selection window. FIG. 18 represents a user interface after the user has selected the tires. The sales associate may click the email button to send future promotions and scheduling for tire maintenance to the customer by email. The “Promotions” button 180 may be used to display a promotion associated with the selected tire.

One embodiment of the present invention allows the user to view all the tires in the specified size range. The details of the entire tire inventory displays in the window. Tire specs may include, but are not limited to, size, price, present promotions, ratings from other users, warranty information, availability, terrain types appropriate for the tire, recommended miles before changing, and the like. A window showing the availability of the tires in nearby maintenance facilities may also be available for the sales associate, technician, and customer to view. In one embodiment, the customer may select numerous tires and compare certain features between them, such as price, promotions, warranties and the like by clicking a “Compare Selection” button. The selected tires may then appear in visual proximity to each other for efficient comparison. Finally, the customer or sales associate may add the tire to the work order by clicking the “Add” button. A final verification shows the details of the tire and final price for the tire.

In one alternative embodiment, the tires, or any other part or service may be presented in an “Intelligent Presentation” feature. The Intelligent Presentation displays the tires based on a variety of parameters that are custom tailored to the customer. Possible parameters for the Intelligent Presentation include, but are not limited to: customer purchase history, customer address, the applicable season of purchase, customer driving habits, customer reviews, customer spending habits, maintenance history of the customer's specific type of vehicle, manufacturer's recommendations, and an indication that customer was satisfied with the part or service. For example, if the customer desires tires, three tires may appear on the display side by side. The first tire may be the least expensive tire, since the customer has a history of purchasing for value. The second tire may be a snow tire since the customer lives in Minnesota. The third tire may also be an inexpensive variety, but also have an extended warranty, because the customer has a history of always purchasing the most extensive warranties for parts and service. The Intelligent Presentation feature provides the customer with relevant options, and increases sales for the maintenance provider. The Intelligent Presentation feature may also associate the customer vehicle information, which may be either obtained manually through the owner's input or by the aforementioned automatic-linking process through a device coupled to the vehicle's processor, with certain tire specifications. For example, if the information from the vehicle indicates the top speed of the vehicle travels over 100 m.p.h., higher speed rating tires are shown. Further, if the vehicle information indicates that the customer travels longer distances at a lower average speed, higher treadwear, lower speed, rated tires are shown.

Another embodiment of the present invention provides a pop-up graphical depiction of a promotional item onto the vehicle. Although this graphical depiction may occur during the walk-in process, e.g., at the kiosk, it is may also occur during the on-line features of the system. Whenever the customer or sales associate selects an area from a graphical representation of the vehicle, the specific vehicle part that was selected converts into a promotional item. For example, if the customer selects a tire with the intent to view tire options, a donut appears in place of the tire. Promotional text would explain to the customer that purchasing a tire from the maintenance provider entitles the customer to a dozen free donuts from a donut provider. The customer would therefore have greater motivation to purchase the tire, and would be entertained by the graphical effects. Movement and audio may also be implemented in the donut/tire. Furthermore, the synergy created between the maintenance provider and the donut provider would provide cross-advertising opportunities. In further promotional embodiments, the oil may convert into a beverage, and the muffler may convert into a travel bag.

One embodiment of the present invention allows the user to select installation options for recently purchased tires. The synergy created by combining parts and service in this manner benefits the maintenance provider by increasing sales and also benefits the customer by providing faster maintenance in a one stop shopping effect. The installation options provides menus that list the possible installation features for the tires such as, but not limited to, alignment, rotation, rims, and the like. Additional services related to the tires, such as alignments and rotations, may also be presented and selected.

In one alternative embodiment, an additional service for tire adjustment may be offered. To obtain this service, the user clicks the “Tire Adjustment” button on the Select Products window. A variety of options may allow the user to view prior tire adjustments, prices, and full adjustment options. After selecting the appropriate tire adjustment, the user may click the “Start an Adjustment on Selected Item” button to proceed with the tire adjustment process.

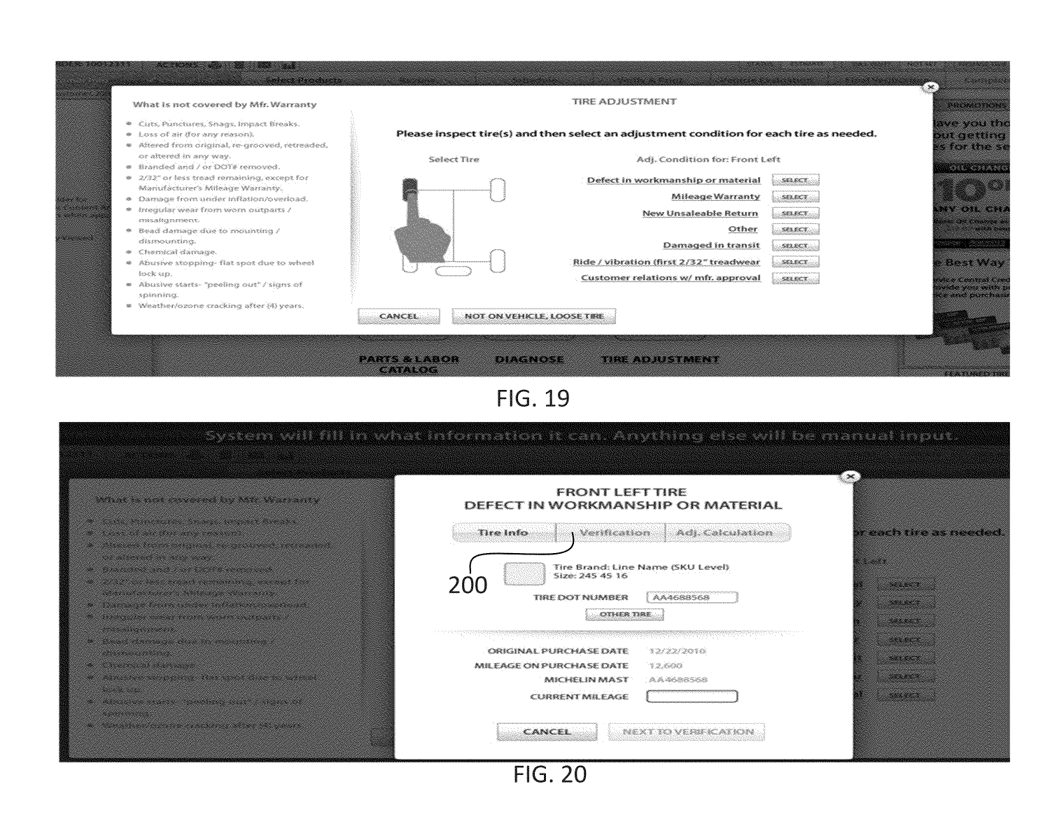

In one embodiment the sales associate may prepare the customer's selected tire adjustment preferences for the technician. The window may include a bar having three steps for adjusting the tires: “Tire Information,” “Verification,” and “Adjustment Calculations.” The tire adjustment window first instructs the user to inspect the tires prior to selecting which tire(s) require adjustment. The inspection process may include measuring the tire's tread. FIG. 19 is an exemplary user interface reflecting the above and the input information required for the method and system for managing vehicle maintenance information to calculate the appropriate tire adjustment. Input parameters may include, but not limited to, exact tire, tire mileage, tire identification number, tire brand, miles since last tire maintenance, and the like. For example, but not limited to, the left front tire is selected to indicate an adjustment for that tire. Other options may include, but not limited to: “Defect in Workmanship,” “New Unsalable Return,” “Damaged in Transit,” “Ride Vibration,” and “Not on Vehicle, Loose Tire.” FIG. 20 shows what the screen might display if the user selects “Defect in Workmanship” for the left front tire. Tire specs are displayed, along with text boxes to enter further information on the tire. Information already stored with on the data storage site will be updated in the relevant text boxes, e.g., the original purchase date, mileage on the purchase date, etc. The verification step may be the subsequent step for the tire adjustment and is shown by link 200 on the interface. Verification requires the technician or sales associate to verify the tire adjustment information. Another embodiment of the present invention includes the “Adjustment Calculation step,” where the tire adjustment is calculated and inputted by clicking a “Done” button. After the information is inputted, the prior tire tread and the new tire tread display on the screen. The user may exit the tire adjustment feature at this point.

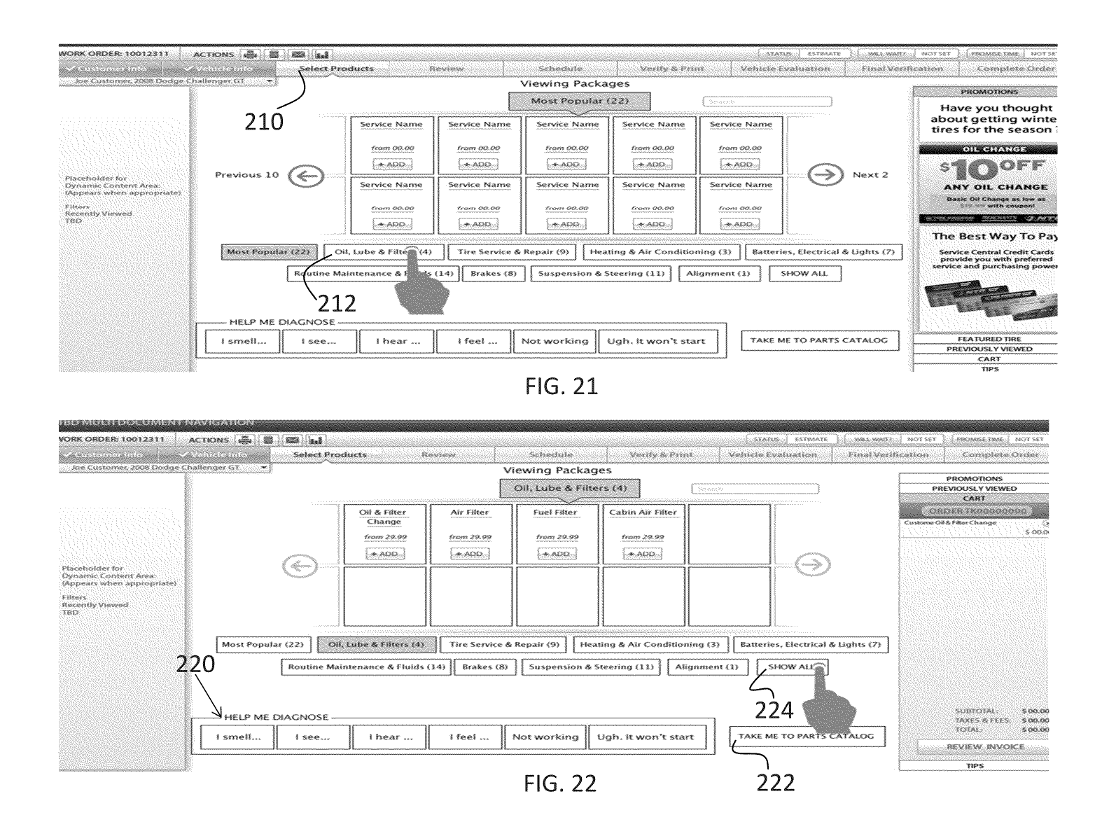

Referring now to FIG. 21, in one embodiment of the present invention, the “Select Product” link 210 which shows a window for selecting a service for the vehicle by clicking the “Service” box. A text box in the window allows the user to type in a specific service. Examples of such services might include, but are not limited to: “new lug bolt,” or “snow tire for sports car.” A “Viewing Packages” feature displays in the “Select Product” window. The services provided by the maintenance facility are presented here, and may include: “Oil Lube & Filter,” “Tire Service & Repair,” “Heating & Air Conditioning,” “Batteries, Electrical, & Lights,” “Routine Maintenance and Fluids,” “Brakes,” “Suspension & Steering,” “Tires Alignment,” and “Others.” A most recommended service is highlighted. This recommendation may be based on large customer usage or promotions. In an alternative embodiment, further services may be included in the “Viewing Packages” window that correlates with technological advances, such as electrical car service needs. FIG. 22 demonstrates the selection of the “Oil Lube & Filter” button 212 (shown in FIG. 21). Further options are available upon selecting the “Oil Lube & Filter” button 212, including, but not limited to “Air Filter,” “Fuel Filter,” and “Cabin Air Filter.” These services may be requested in addition to the oil lube service. Assorted price ranges are also presented for various types, viscosities, and qualities of the oil and filter. The “Diagnosis” button 220 is also available in the service window. Clicking the “Diagnosis” button 220 allows the user to more efficiently diagnose problems with the vehicle. The options are physical sensory detections that include, but are not limited to “Smell,” “Hear,” Won't Start,” “See,” and “Not Working.”

Another option available upon selecting the “Oil Lube & Filter” button 212 (shown in FIG. 21) is the “Take Me To Parts Catalog” button 222. Clicking this button 222 may provide a catalog of available parts at the maintenance facility, or other maintenance facilities. A “Show All Button” 224 provides the complete list of oil and filter service options. Clicking the “Show All Button 224” results in the “Viewing All Packages” window appearing (shown in FIG. 22). The “Viewing All Packages” window displays the categories and subcategories of services. For example, under the “Brakes” category, the user has the options of selecting: “Brake Inspection,” “ABS System Diagnosis,” “Brake Pad Replacement,” “Brake Shoe Replacement,” “Brake Rotor Replacement,” and the like. After the subcategory is selected, the manufacturer of the product or part may be selected by the customer. In one embodiment, specific manufacturer for the oil and oil filter display, giving the customer further options. Promotion from the specific manufacturers of the oil may also display in conjunction with the oil. Finally, a description of the required labor displays to justify labor costs and educate the customer. The complete availability of oils and filters graphically display after the selections are complete.

Another embodiment of the present invention, referred to as the “Service and Parts Itemization” feature, creates an accurate inventory for labor costs and parts utilized for that service. For each service performed, the computer system deducts the pertinent parts and man hours utilized. For example, for a brake replacement service, the computer system would deduct a caliper, a rotor from the inventory, and 1.3 man hours from the scheduling calendar. The parts may then be compensated for from the warehouse and the reduction in man hours may result in the customer being moved to a future maintenance date. The “Service and Parts Itemization” feature is beneficial because it allows the maintenance provider to contain costs, the maintenance facility to schedule maintenance visits more efficiently, and the customer to become more educated on the maintenance provider's pricing. The “Service and Parts Itemization” feature also advantageously allows the service provider to budget for the upcoming week or month.

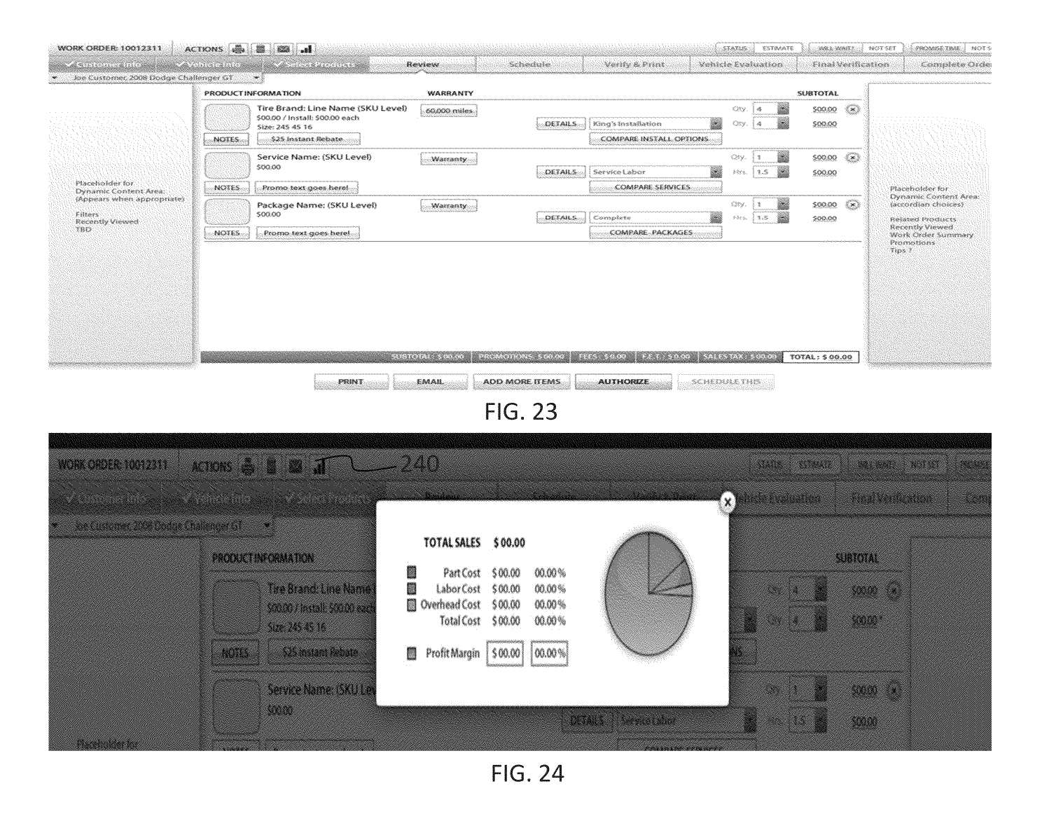

In one embodiment, as shown in FIG. 23, a work order review window displays to verify a complete assessment of the selected maintenance and parts. The work order review presents a detailed analysis of the selected maintenance, parts, labor, and costs. In one embodiment, the work order review may be amended to reflect changes by the customer or technician as maintenance progresses. Any changes may then be automatically updated to the other users involved, e.g., the associate and customer, for notification and/or approval. The present invention may provide for the other users to be automatically updated without the use human intervention, thereby further increasing efficiency. Product information in the work order review may include notes about the vehicle that were taken by the sales associate during the walk around. These notes become a part of the vehicle maintenance history, and may later be utilized by the technician. For example, damage to the vehicle prior attempts by the customer to self-maintenance the vehicle may be noted. Information regarding the warranty for parts and labor also displays in the work order review screen. Additional maintenance or installation options are also available. The subtotal is also displayed, and may be adjusted to reflect promotions and errors with the maintenance.

The work order review may also display a graphical representation of the total sales for assisting the sales associate or an accountant to analyze the sales, represented in FIG. 24. Clicking the “Sales Graph” button 240 may generate a pie graph. The pie graph is a graphical representation of the total sales are separated into “Part Cost,” “Labor Cost,” “Overhead Cost,” and “Labor Cost.” Profits are also calculated from these numbers, represented as a dollar amount, and as a percentage of total sales. The “Sales Graph” button 240 provides some of the advantages found in the above discussed “Service and Parts Itemization” feature.

In an alternative embodiment, a fast quote appears on the portable electronic device after all parts and service selections have been decided. The fast quote is detailed, itemized, and graphic for providing instant recognition of the costs involved with minimal confusion. The fast quote allows the sales associate to more efficiently conclude the sale and transfer the vehicle to the technician to commence the work. The customer also receives assurance of knowing exactly how much the maintenance visit will cost while simultaneously performing the walk around. In this manner, if the customer has a maximum budget, a stopping point may be established during the walk around.

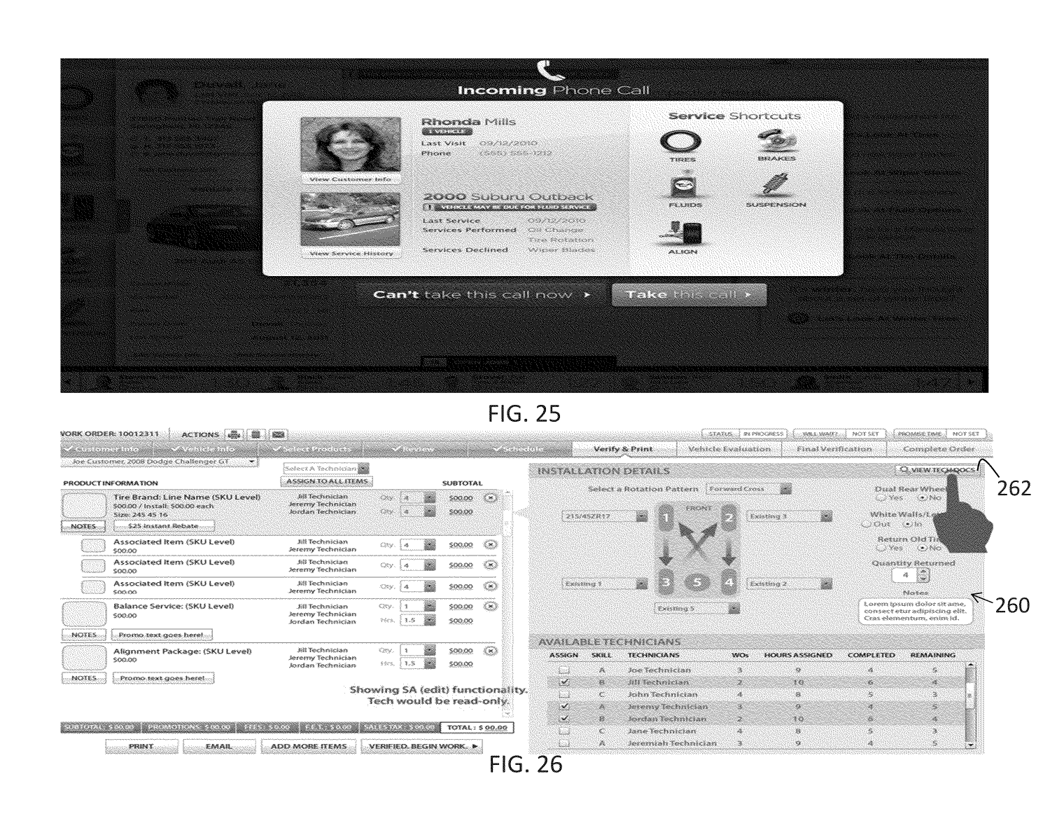

In one embodiment represented in FIG. 25, incoming phone calls are recognized and associated with customer information on file to provide efficient and consistent service to the customer. The computer system automatically correlates the incoming phone call with customer information such as the customer's phone number in the maintenance data storage site. The point-of-sale display screen immediately displays information pertinent to the customer upon receiving the phone call. Generally, however, it is only the display which both the sales associate and the technician have access to, that displays the customer information. A photograph of the customer and the vehicle may also appear on the display, along with options to provide services, parts, and promotional offers to the customer. In one alternative embodiment, a scripted greeting appears on the display. The script changes throughout the phone conversation as the sales associate selects different options for the customer. For example, but not limited to, the initial script recites, “Thank you for calling [Vehicle Maintenance Provider], home of the low price guarantee. This is [Name], how may I help you?” Then if the customer requests a tire for the vehicle, the sales associate clicks “tires” on the display and the script changes to, “Great, I'm glad you called. Did you know the size, or would you like me to look that up for you?” If the customer was returning, or the customer's vehicle was recognized, the associate may already have the tire specifications. The sales associate would then continue reading from the script, improvising when necessary based on past knowledge and experience with the customer.

In an alternative embodiment of the present invention, a vehicle maintenance automated hotline would be available to the customer. The vehicle maintenance hotline would allow the customer to inquire about information pertinent to vehicle maintenance, such as, but not limited to: maintenance recommendations, parts, breakdowns, vehicle features, prices, and promotions. If the customer decided to obtain maintenance, a specific button, such as a “#” button on the telephone could be pushed. The customer would then be directed to a live operator or sales associate to schedule maintenance. However, a further embodiment would allow the customer to schedule maintenance through the computer system. By utilizing the vehicle maintenance hotline, the customer could avoid any sales pressure by calling the hotline.

In one embodiment referenced in FIG. 26, a “Technician Dashboard” provides the technician with the capability and information to efficiently service the vehicle. The Technician Dashboard includes numerous components, some of which the technician may interact with, other which are read only. A Product Information feature displays the pertinent parts for a desired service. The part number, price, warranty information, required service for installation, special notes, and promotional information display for the technician to access. The technician may also access additional parts that may be more appropriate for the service. Another feature is the “Installation Details” window 260. This feature assists the technician with the installation. A “View Technical Documents” button 262 introduces maintenance publications for the technician to review, such as the digitized manufacturer's manual and the vehicle maintenance history. A graphical representation of certain vehicle components that are being serviced may also appear on the display. For example, if a tire rotation is requested, the four tires and two axles display. A drop box provides options for the direction of the rotation (e.g., forward cross, rear cross, etc), and arrows help the technician visualize the rotation process. Selection boxes allow the technician to denote the tire types being utilized along with other specifications of the tires. There is also an area for the technician to make notes for future technician reference and customer inquiries. An “Available Technicians” feature allows the technician to view the availability and work load of other technicians in the maintenance facility. This feature helps to coordinate the activities and break periods for the technicians. The sales associate and management may also view this information for vehicle scheduling and labor cost management.

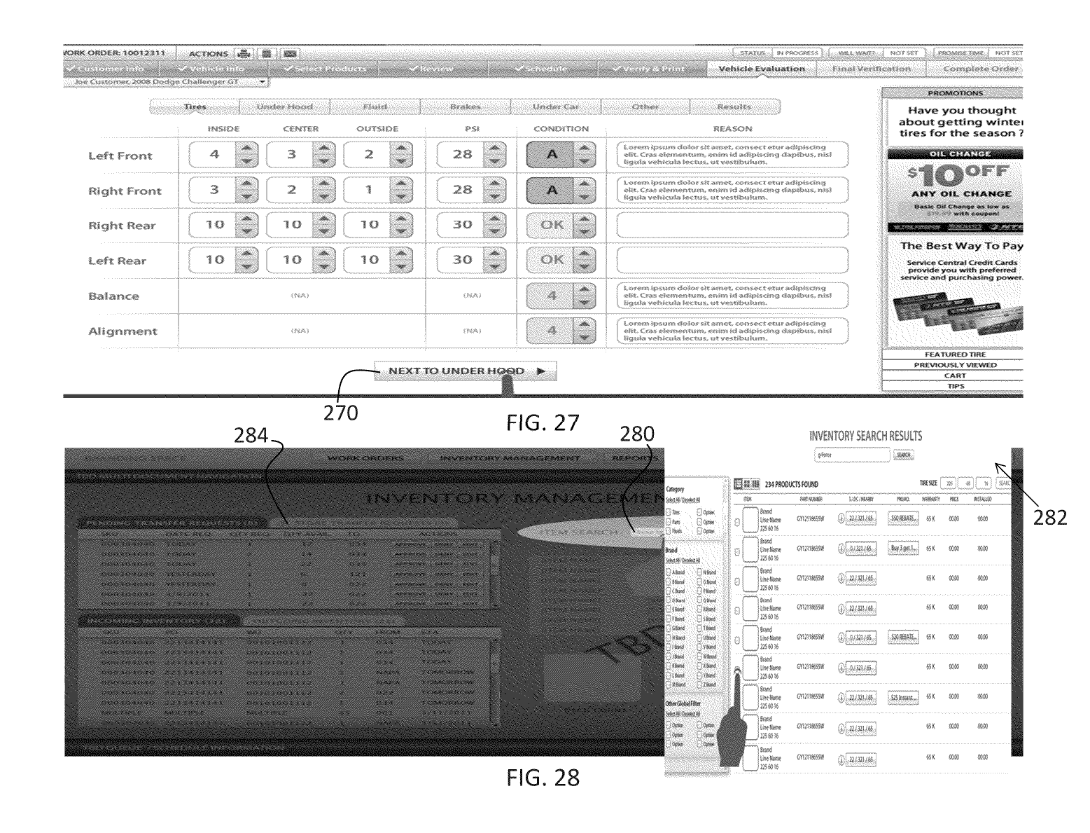

In an alternative embodiment to the “Technician Dashboard” referenced in FIG. 27, includes a “Vehicle Evaluation” feature for assisting the technician during servicing and verifying that all steps and procedures were followed by the technician during the vehicle servicing. The technician records incremental steps during the vehicle servicing to enhance the vehicle maintenance history. For example, after rotating the tires, the technician records the tire tread depth, tire air pressure, and general condition of each tire. Text boxes and drop boxes provide fast access while the technician simultaneously services the vehicle. The tire information provides a maintenance history that may be utilized by future technicians, the customer, and the scheduling calendar for future tire maintenance visits. This information may also be used track a technician's compliance with tire and other part specifications, which is beneficial should the customer return with issues relating to service or should the part malfunction. After the information has been entered, the technician may click a “Next To Under Hood” button 270, which provides additional options. The options may include additional part and service recommendations such as higher quality tires, tire balancing options, and the like. The technician may then contact the customer and the sales associate to make the appropriate recommendations. A “Final Verification” feature queries the technician about the service, verifying that all steps and procedures were followed during the service. An example may include querying whether the technician “Completely drained crankcase of oil?” or “Installed oil filter?” In this manner, the technician is assured to not overlook a step while servicing the vehicle.

Another feature of the present invention provides a comprehensive “Inventory Management” feature, represented by windows open from the user interface shown in FIG. 28. In one embodiment, inventory management is primarily concerned with specifying the quantity and percentage of stocked vehicle parts and man hours worked in the maintenance facility. However, further embodiments may include transferring parts between maintenance facilities, searching for parts, performing a deck count, documenting returns, managing P-Cards, performing full inventory scans, rewarding employees, and the like. Inventory management may be required at maintenance facilities or within many locations of a supply network to precede the regular and planned stocking of vehicle parts and scheduling of technicians.

Further, FIG. 28 also represents that the sales associate, or the technician, may utilize the “Inventory Management” feature to search for a vehicle part. An “Item Search” text box 280 allows text to be typed in for a specific part, such as, but not limited to a Boolean search, or a key word search. The query results in a list 282 of parts containing the specified word or phrase. The desired part may be selected. Detailed information pertinent to the part is also displayed, such as manufacturer, promotions, location of parts, size, type, price, availability, and the like.

Often, nearby maintenance facilities do not have access to certain vehicle parts. To resolve this dilemma, one embodiment of the “Inventory Management” feature allows multiple maintenance facilities to transfer parts between each other, and make a record of the transfer. In this manner, the inventory warehouse is aware of the quantity and type of parts in each maintenance facility, and each maintenance facility is aware of its own supplies. A “Store Transfer” tab 284 displays all requests for parts made to the maintenance facility. The maintenance facility may then deny or agree to the requested transfer of parts. A “Notes” text box provides space for explanations for the denial of transfers between maintenance facilities. An “Outgoing Inventory” tab displays all the parts that will be transferring to another maintenance facility, or returns to the manufacturer for defects.

Further embodiments of the “Inventory Management” feature allow the maintenance facility to perform a deck count, scan inventory, prepare purchase orders, and perform an adjust items count. These functions may be performed also by the portable electronic device. The complete inventory in the supply warehouse and in each individual maintenance facility may be instantly recorded and adjusted in relation to each sale, transfer, return, or loss. The “Inventory Management” feature provides real-time access to every part in stock. For example, if a maintenance facility sells an oil filter from manufacturer ABC and that oil filter is not available, but on transfer from another store, the date and time of expected arrival appears on the point of sale display or portable electronic device display. However, if the customer changes to request a DEF filter, the ABC filter transfer order is cancelled, and the maintenance facility simply orders a case of ABC filters with a simple purchase order from the manufacturer for future demand. The ABC filter remains in the inventory stock of the original maintenance facility.

Another embodiment of the “Inventory Management” itemizes parts and labor costs. For each service performed, the computer system deducts the pertinent parts and man hours utilized. For example, for an oil change, the computer system would deduct an oil filter, five quarts of 5W-40 oil, and 0.5 man hours from the scheduling calendar. The parts may then be compensated for from the warehouse, and the reduction in man hours may result in another customer being moved to a future maintenance date. The “Inventory Management” feature is beneficial because it itemizes both parts and labor.

In one alternative embodiment, the “Inventory Management” feature awards “chips” to employees such as warehouse clerks, sales associates, and technicians who inventory properly and create value for the maintenance provider. After accumulating so many chips, the employee may receive bonuses and awards. This incentive feature to motivate employees is recorded and displayed along with parts and man hour inventory.

In another embodiment, transactions are conducted efficiently and by utilizing the most up to date technology. Cash, checks, or credit cards may be processed instantly with portable electronic devices, in person, and over the internet. However, other forms of payment now known or later developed may also be utilized. All parts and services are detailed for the customer to easily review, and a work order and receipt may be printed out for the customer.

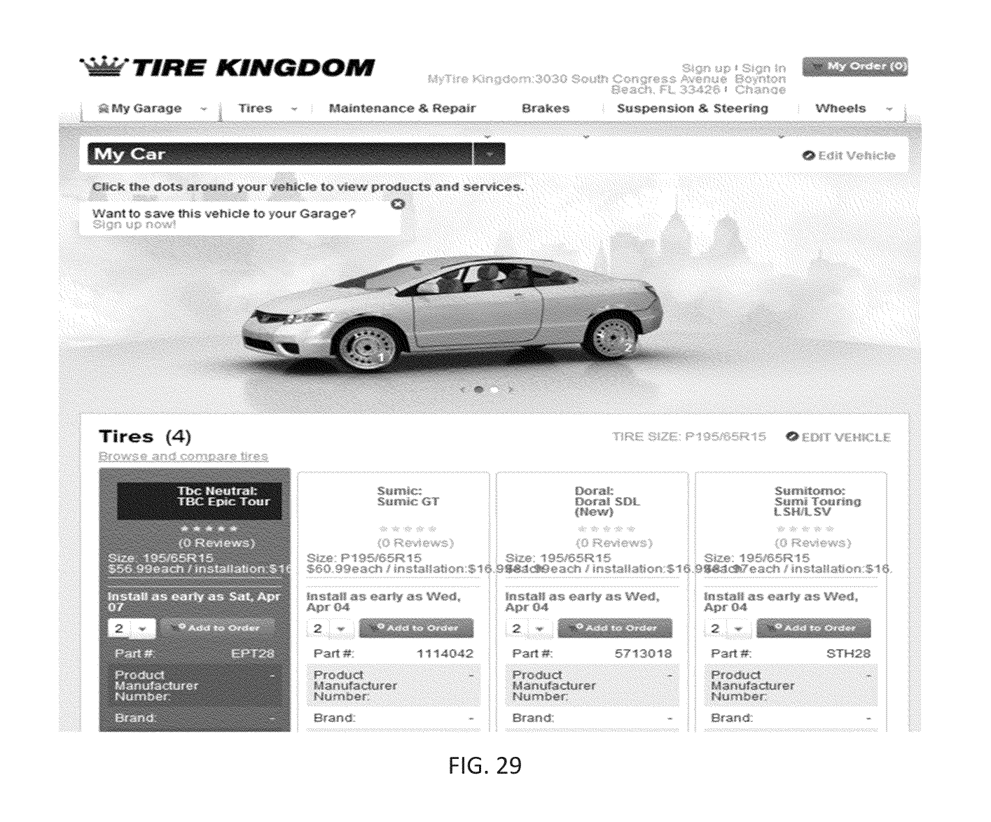

Although many of the above features were discussed with reference to the check-in process, these features may also be available and accessible to the customer, or any user, while not at the facility of the service provider. As such, the user may also interact, update, and exchange information with the vehicle service provider while the user is located at a remote location, i.e., through the internet. One example of a feature of the present invention, represented in FIG. 29, the system and method provides a virtual comprehensive vehicle maintenance tool to the customer, previously referenced as the “E-Garage.” The E-Garage provides a 24/7 accessible portal for the customer to learn more about the vehicle, vehicle maintenance, parts information, maintenance scheduling, and pricing. The customer may also access and contribute vehicle maintenance information for numerous other vehicles, such as a family member's vehicle or a company fleet vehicle. The customer may interactively contribute to the vehicle maintenance history and scheduling for maintenance by inputting vehicle information remotely from the internet or from the point of sale device at the maintenance facility.

Typical vehicle information may include, but is not limited to, mileage, miles driven per day, dates for last maintenance, damage to vehicle, and the like. The vehicle information automatically becomes a part of the vehicle history, and is accessible to the remote vehicle maintenance data storage site. The E-Garage is accessible at any time to provide the customer with answers for technical questions, schedule maintenance, and predict future maintenance needs. The E-Garage window may present a graphical depiction of the customer vehicle. Updated vehicle information such as, but not limited to mileage, last maintenance visit, and scheduled maintenance visits appear in conjunction with the vehicle. The graphical depiction of the vehicle includes “hot spots,” which are localities on the vehicle such as, but not limited to, tires, muffler, engine, and the like. The customer may click a specific hot spot to inquire about parts or maintenance issues pertinent to that area on the vehicle. In one embodiment, the customer may click a hot spot located on a tire to view a list of tires that are appropriate for the vehicle. Tire features such as, sizes, manufacturer brands, prices, warranty specs, tire services, promotions, and the like also display in conjunction with the tire list. The customer then has the option of simply learning more about the tire options, purchasing the tires online, or scheduling maintenance visits for further information or tire service.

Through the E-Garage, the customer may learn more about maintenance recommendations and options prior to arriving at the maintenance facility. One example may include a customer who is not aware when the vehicle requires an oil and filter change. By accessing the E-Garage, the customer is reminded that the last oil and filter change for the vehicle occurred 4,000 miles prior. The E-Garage then informs the customer that the recommended oil and filter change interval for the vehicle is 3,800 miles. The customer may access this same information for multiple vehicles belonging to other family members or a company fleet. In one alternative embodiment, the E-Garage allows the customer to interactively contribute to the vehicle's maintenance. For example, the maintenance provider may supply the customer with a tire gauge. The customer periodically checks the vehicle's tire tread depth with the gauge, and inputs the information into the E-Garage. The E-Garage may then text or e-mail the customer for further information, such as mileage driven per day, or warranty preferences. A processor then calculates and extrapolates to determine whether the customer requires tire maintenance such as new tires, an alignment, or a tire rotation based on this information. The E-Garage may also combine factors such as the mileage driven with the past tire tread depth to calculate and extrapolate future scheduled maintenance. The E-Garage then alerts the customer by text or email about the scheduled tire maintenance. These features provide the customer with more knowledge and control over the maintenance of the vehicle.

In a further embodiment, the E-Garage provides a virtual comprehensive vehicle maintenance feature that is unique to each customer and vehicle. The customer is provided with a unique log capable of providing exclusive access to the vehicle's maintenance information. Further, in one embodiment, the E-Garage may display a graphical representation of the customer's vehicle and by clicking on a “hot spot” on the vehicle, such as a tire, the customer may then obtain a variety of information pertinent to tires and tire maintenance, such as: tire sizes appropriate for the vehicle, tire prices, tire promotions, tire service options, tire warranty availabilities, and the like. This is akin to the process of selecting a hot spot while in the store, as described above, except that now the selection is done at a remote location. These “hot spots” may be located at each section of the vehicle where the service provider offers parts or service. A typical E-Garage embodiment may also provide a digitized manufacturer's manual for the specific vehicle model and year. The E-Garage may provide the digitized manufacturer's manual for almost every vehicle produced. Since the manuals are digitized, the E-Garage may query the recommended maintenance schedule for the vehicle based on the manufacturer's recommendations. For example, but not limited to, a 2006 Ford Taurus may require a tune up at 60,000 miles. The Customer is informed of this maintenance recommendation by text, email, phone, or mail upon reaching 59,500 miles. However, in alternative embodiments, the E-Garage has the capacity to factor in other variables such as, but not limited to, mileage driven, quality of parts, and vehicle history to recommend maintenance visits that differ from the manufacturer's recommended maintenance schedule. The manufacturer's manual scheduling calendar is graphically presented to the customer so as to facilitate comprehension. For example, a tire graphic correlates to tire maintenance, and an oil can correlate to oil and filter change recommendations. The manufacturer's manual may be accessible on the E-Garage as a .pdf file, an html format, or any other format now known or later developed.

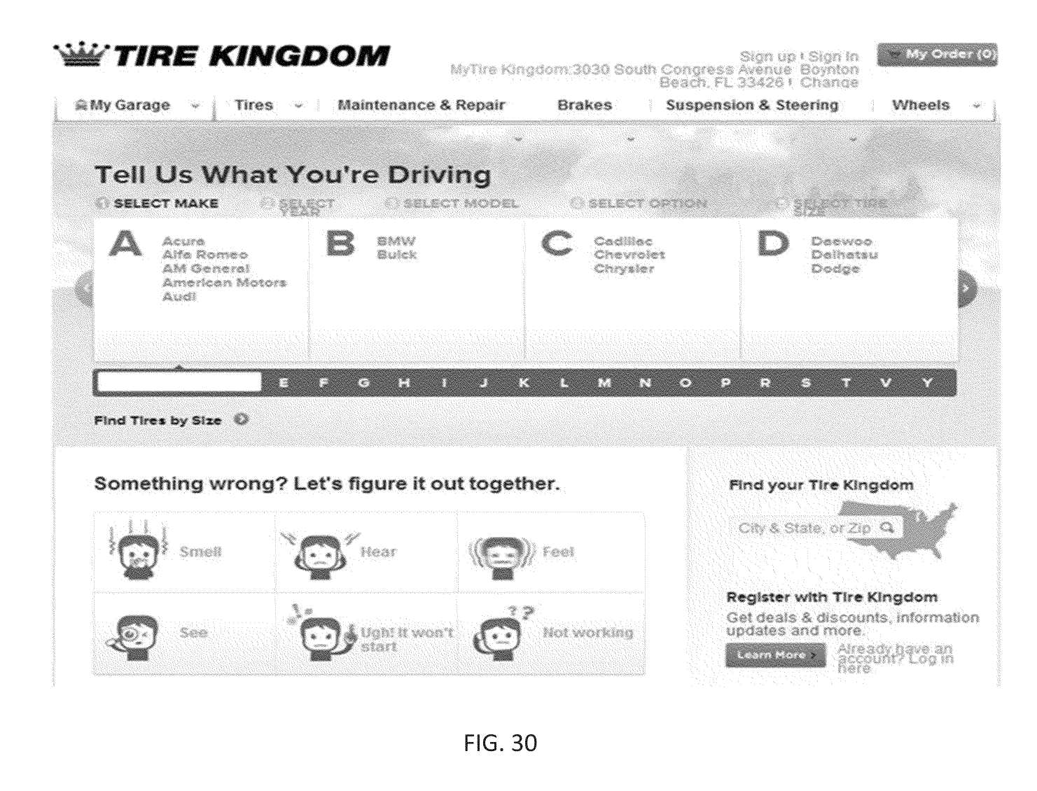

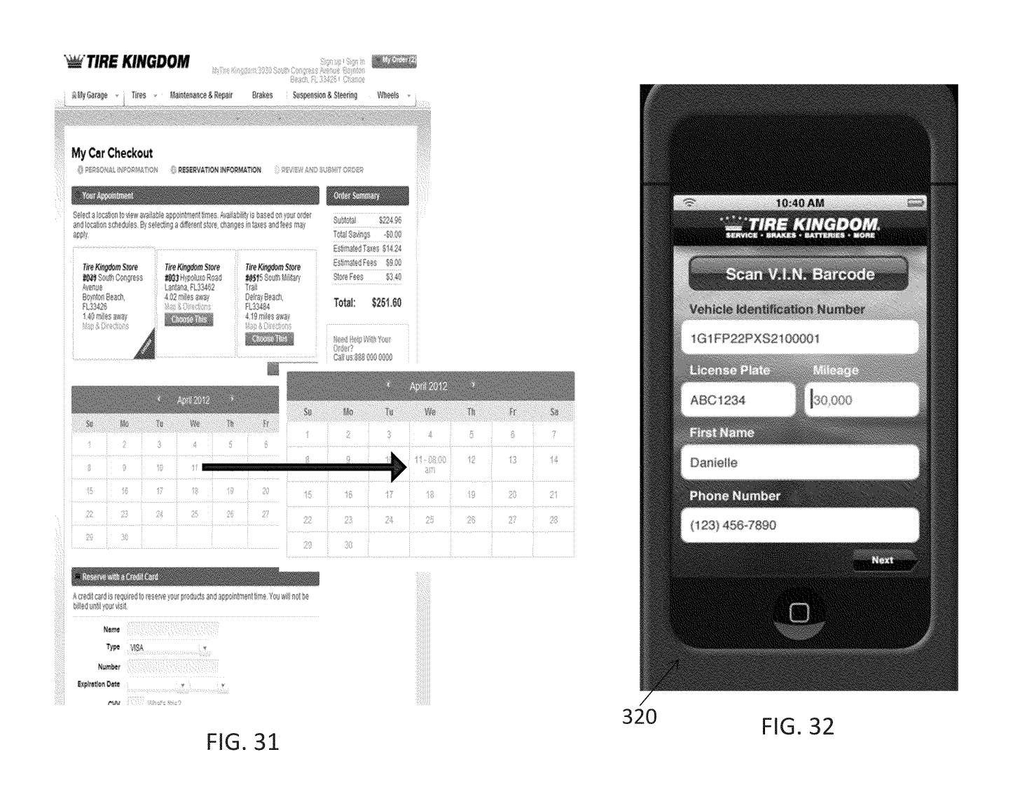

FIG. 30 represents the online version of the aforementioned symptom detector that helps the customer diagnosis issues being experienced on the vehicle. As previously discussed, the symptom detector may have audio or visual indicators that facilitate the customer in inputting the proper information. This advantageously allows a customer to associate and relay any problems with the vehicle to the service provider being able to remedy those problems. Consequently, any parts or services may then be purchased and services could be scheduled online with time being wasted at the service provider's facility. When the customer appears for their appointment, the parts, which would be on stand-by or located in the facility's inventory, and scheduled service(s) may then be confirmed, verified, and performed by the service provider. FIG. 31 exemplifies a checkout screen whereby the customer may pay for and locate a convenient time and place to schedule those service(s).

Referring back to the walk-in process involving the customer, the service provider may have the ability to scan or input information with a portable device 320 as shown in FIG. 32. This advantageously allows the service provider to potentially scan the V.I.N. barcode of the vehicle which would bring all of the customer and vehicle information needed without obtaining it from the customer. As such, the device may have a scanner operable to receive the information stored on the barcode, that information would then be compared to data structures held in a data storage base wherein the customer information is loaded on the device. In other embodiments, the device is operable to receive a signal that is transmitted from a transmitter, e.g., an RFID tag, which contains, or has a code that associates to, all of the customer information. The transmitter may also come in another form that transfers data to an electronic device. As such, after a service provider initially obtains all required customer and vehicle information it may issue the tag or transmitter to the customer. This tag may then be placed on the customer's vehicle or a customer's key chain where it may then be scanned by the service provider. This leads to a more efficient and effective check-in process that is not generally accomplished with the prior-art vehicle maintenance systems.

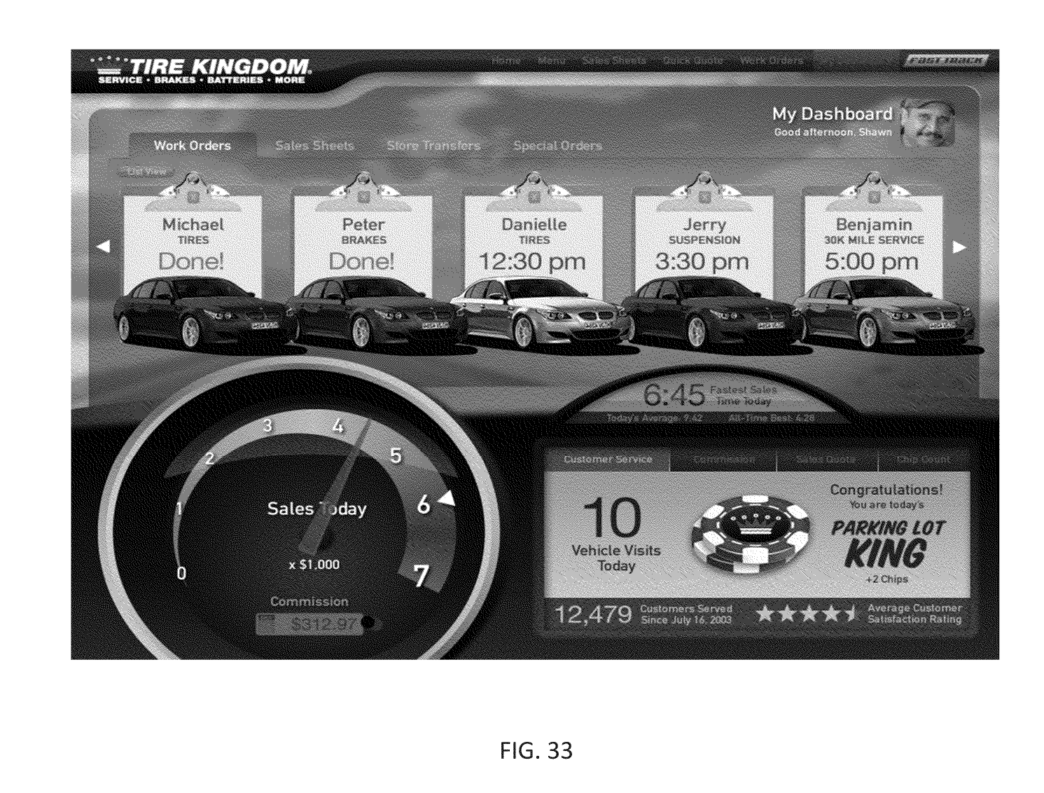

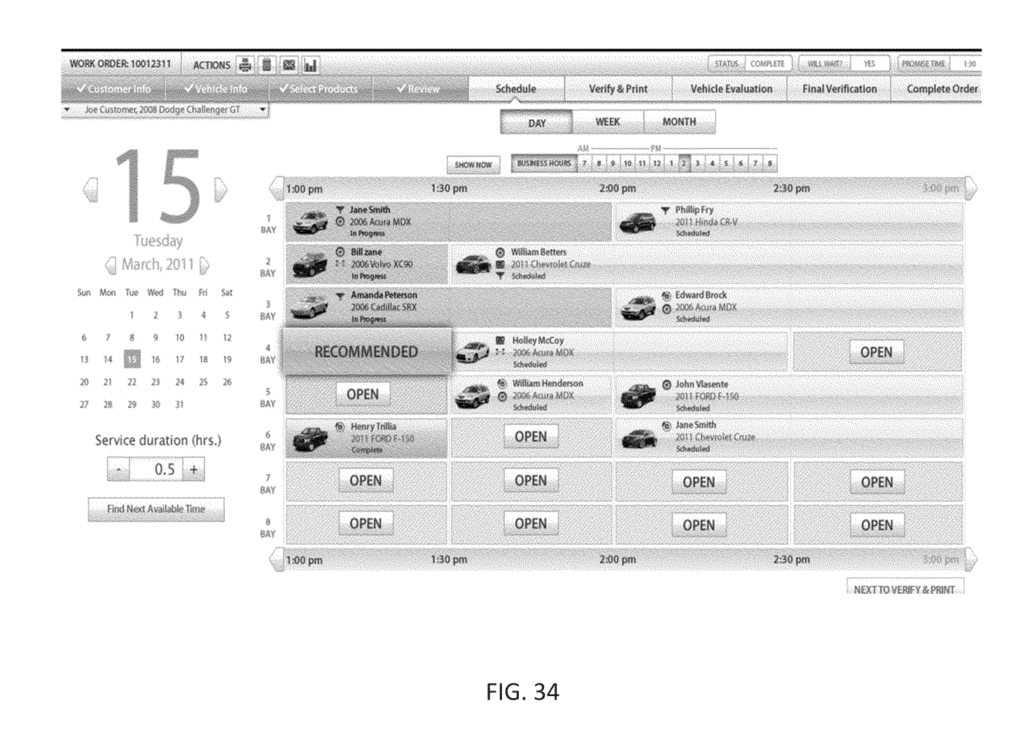

FIG. 33 is a user interface representing another feature of system visually depicting the aforementioned incentive system for those associates, or other employees, working for the service provider. This visual depiction displays all past, current, and future appointments for the service provider's facility. In one embodiment, the system features a meter reflecting the total sales of the associate and the commission associated with said sales. As the system is capable of being communication with more than one store of the service provider, the interface may also show the average service and sales times over all facilities and the associate's, or facility's, production compared to these averages. In other embodiments, other graphically representations, besides a gauge meter, may be utilized and the incentive system may also be applied to the technicians based upon service time completion based on the average service time. Awards, in the form of chips, are also visually depicted in this embodiment. Although there many different variations described herein for viewing of the service schedule, FIG. 34 presents a scheduling interface whereby the associate may view each bay by the time of the day, specifically showing the vehicles “in progress” and available time slots.

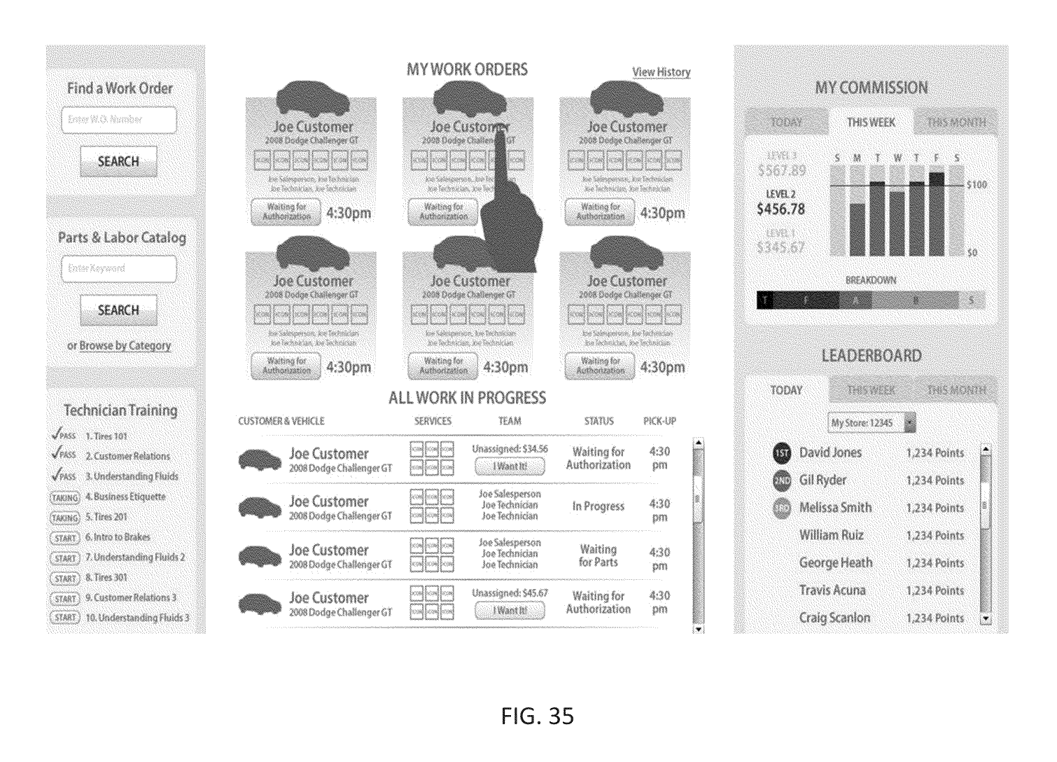

FIG. 35 depicts a user interface representing the aforementioned incentive system as applied to the technicians of the service facility. The commission for each technician is displayed along with points for each technician. In one embodiment, the points may be associated on time completion of an assigned maintenance service. The points may also be associated based upon completion of technical training, complexity of service, or other parameters. As each technician may be compared to other technicians, those technicians may be motivated to complete a job faster than it might ordinarily be done. Furthermore, the user interface graphically depicts all of the technician's current work orders for the day and time scheduled for said work order, which helps the technician better manage his or her time. Also listed on the interface of the system is the “technical training” task bar, which represents all of the training courses completed or scheduled by the technician. Further, a technician may view and claim current open work orders that are not assigned to any technician.

A novel system and set of methods has been disclosed that provides dramatically-improved vehicle management and maintenance information. The novel invention, more particularly, provides a vehicle maintenance system that utilizes information obtained from a vehicle owner and a vehicle service provider and alerts and educates the vehicle owner and the vehicle service provider about recommended maintenance scheduling, specific vehicle parts and repair requirements, vehicle diagnosis information, vehicle service history, real-time inventory management, vehicle maintenance costs, and scheduling of vehicle owners for vehicle maintenance at the maintenance facility.

As described above, the invention provides a user to become a “Fleet Manager” or “E-Garage” owner. The user can remotely access, i.e., log in to, the system periodically to enter the mileage of each car in their family and graphically see how much time each vehicle has before upcoming services are needed and what those services will be. The novel system provides a solution to those persons that are not aware of the lifespan of, for example, the brakes, oil, tires, etc. in their own car, as well as those of their family members. In addition to having this valuable knowledge, user can simply click on the graphically-displayed hotspot on the automobile being displayed and immediately receive a quote and the ability to schedule the needed service at the service provider. To more accurately predict/advise/schedule services, periodic mileage queries can be made and responded to by the user via text messaging or a mobile app. In further embodiments, users can be provided tire-tread gauges so that they can measure and report their tread measurements to the system, e.g., a website, at certain intervals. The tread wear can be used, for example, to identify a need for alignments, a tire rotation, a tire replacement, etc., and to schedule said services.

The present invention also provides for inventory of time units. That is, for each service ordered by a customer, a specific amount of time and the parts needed to complete the service are attributed to the order. For example, a requested brake replacement service would capture calipers, rotors, disk-squeak-stopping material, and 1.3 hrs of technician/bay time. These items (including the time) are then subtracted from that store's inventory for the day of scheduled service. This method of calculation, rather than simply scheduling customers from a first time period to a second time period, has proven to be a better utilization of each location's resources and will allow for more precise scheduling and stocking of parts.

The present invention further includes an intelligent caller ID phone system. Embodiments of the intelligent caller ID phone system instantly presents customer information on a screen with all of their automobile information displayed or instantly available to the technician receiving the call. Because a vehicle, if not properly maintained, can become a potentially dangerous mechanical structure with many parts that wear down/wear out, the present invention advantageously allows the technician to instantly recognize and inform the owner/driver of upcoming events.

In accordance with one embodiment, the present invention provides a hotline where people are encouraged to call and learn about their vehicle and its current and upcoming needs without any pressure from a salesperson. When services is needed and/or desired, the user can then press a button, for example, to schedule service. A technician can even come to the user's house to pick up the vehicle for service.

In accordance with yet another feature of the present invention, service schedules for vehicles are extrapolated from information obtained via text messaging or other instant communications devices/techniques. For example, at a point in time approximately ¾ of the way between the last service and the next scheduled service (which was set based on calendar months), the owner of the vehicle will receive a text message asking them to enter their current mileage. Based on this input, the next service date can be extrapolated and scheduled. During a heavy driving period, the person can be assured not to exceed the life of their oil, transmission fluid, etc. because the miles were transmitted and the system identified the need for accelerating the service date. On the other hand, one might be able to stretch a service out and save some money during low mileage spans, thus motivating them to participate in the text correspondence, which could also include advertisements.

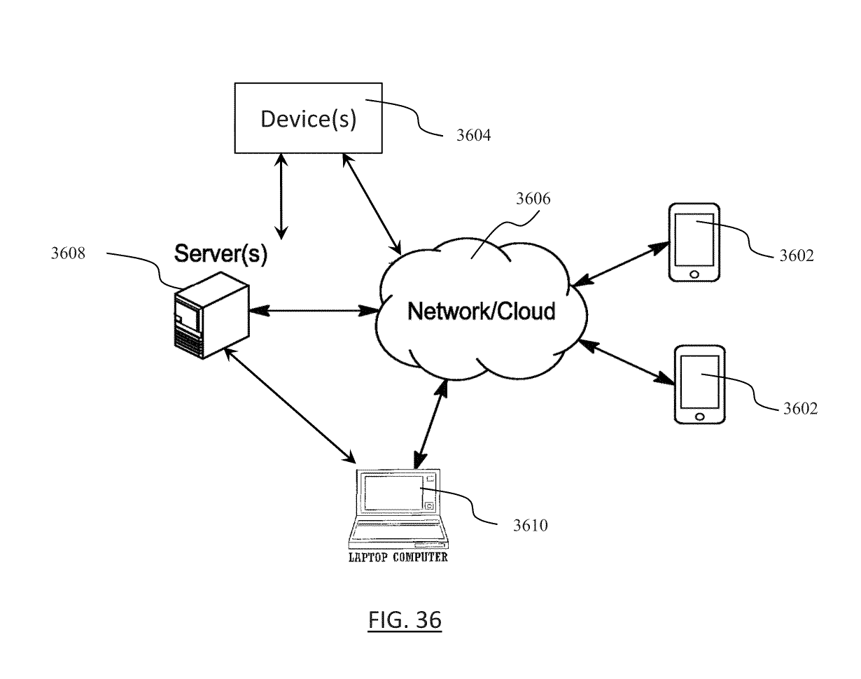

Referring now to FIG. 36, the present invention may include an intelligent tracking system and method for providing customers with information relating to the progress and steps of a technician maintaining a vehicle. The invention may further allow the customer to purchase replacement parts through a portable electronic device 3602 after the technician or the software itself ascertains the need for a replacement part. The invention may include one or more devices 3604 that track the progress of the user's vehicle maintenance. The one or more devices 3604 transmit information related to the progress and steps of the maintenance process through a wired or wireless connection over a network 3606, where the network may include the Internet.

For example, in some embodiments, one of the devices 3604 is an electric lug nut drill that will monitor and generate information identifying whether the appropriate number of lug nuts have been properly tightened. The devices 3604 may be in communication with a centralized computer server 3608. The centralized computer 3608 may provide the one or more devices 3604 with information, such as the number of lug nuts on the vehicle or the amount of amount to dispense into the engine of the vehicle. The one or more devices 3604 will then facilitate the transmission of vehicle maintenance progress information to a centralized computer system 3608. The information is stored into a database (not shown) for maintaining a record of the completion of maintenance steps.

In some embodiments, the technician may submit, through a separate computing device 3610, such as a laptop or tablet computer, that each task has been properly completed. For example, the technician may enter into the computing device 3610 that oil has been added to the vehicle. Additionally, the technician may enter the exact amount of oil added to the vehicle. This information is recorded and in some embodiments is transmitted to the customer's portable electronic device 3602. The information may be transmitted to the customer in real time. Alternatively, the information may be transmitted to the customer in near-real time. In some alternatives, the information may be transmitted to the customer subsequent to the performance of the vehicle maintenance. The transmission may be facilitated by way of a message, such as SMS messaging, iMessage messaging, emailing, or other similar modes of transmission. Alternatively, the information may be accessed by the customer through an Internet connection or a portable electronic device application, which allows the customer to be assured that maintenance, was properly performed at each step.

For example, an application residing on portable electronic device 3602 allows the customer to monitor the progress of their vehicle maintenance in real time. This also allows the customer to become aware of issues or areas of concern in real time or near-real time. The application alternatively allows the user to view maintenance performed, areas of concern, and technician suggested maintenance, to name just a few. In this manner, the customer can use their portable electronic device to verify that all maintenance and inspection tasks items have been performed properly prior to the customer leaving the physical store location. In the event that the technician determines that any parts need to be replaced, the customer may be alerted through a message or the application. The alert may include the part that should be replaced and suggest replacement parts. The system allows the customer to respond in kind, via a message or through the application, with a selection of parts to be replaced. For example, the customer may able to select particular tires, oil filters, windshield wipers, and or any other vehicle part. This allows for better utilization of resources because the customer can quickly select replacement parts that the technician can install.

What is claimed:

1. A computer-implemented method to interact with a user and a customer, the method comprising:
receiving, from a portable electronic device of a customer, a mileage of a vehicle at an electronic computing device communicatively coupled to the portable electronic device over a network;
advising, based on the received mileage of the vehicle, of a need to schedule vehicle maintenance, the advising performed without customer interaction; and
scheduling a customer selection of calendaring items for maintenance of the vehicle, the calendaring items including at least one of a date and time and at least one of a maintenance bay and a technician.

2. The computer-implemented method of claim 1, the method further comprising:
displaying graphically, using customer data, at least one of previous maintenance dates and future maintenance dates.

3. The computer-implemented method of claim 1, the method further comprising:
representing graphically, to the user, occupied maintenance times.

4. The computer-implemented method of claim 1, the method further comprising:
representing graphically at least one of a need for vehicle maintenance and services needed.

5. A computer-implemented method to interact with a customer, the method comprising:
receiving, from a portable electronic device of the customer, vehicle maintenance data relating to a diagnosed problem of a vehicle by an onboard diagnostic system;
analyzing, at a centralized computing server, the diagnosed problem; and
transmitting, to the customer prior to customer arrival at a maintenance facility, an analysis of the diagnosed problem of the vehicle.

6. The computer-implemented method of claim 5, the method further comprising:
storing, into a customer database, the vehicle maintenance data.

7. The computer-implemented method of claim 5, the method further comprising:
facilitating, to the customer prior to customer arrival at a maintenance facility, a digital communication to the customer indicating whether the vehicle is in a safe operating condition.

8. The computer-implemented method of claim 5, the method further comprising:
transmitting, to the customer prior to customer arrival at the maintenance facility, a price quote to fix the diagnosed problem of the vehicle.

9. The computer-implemented method of claim 8, the method further comprising:
receiving, from the portable electronic device of the customer, a scheduled maintenance appointment to fix the diagnosed problem of the vehicle.
